(19) United States
(12) Patent Application Publication
(10) Pub. No.: US 2014/0205962 A1
(43) Pub. Date: Jul. 24, 2014

(54) Orthodontic Bracket

(71) Applicants: Paul L. Damon, Spokane, WA (US); Dwight H. Damon, Spokane, WA (US)

(72) Inventors: Paul L. Damon, Spokane, WA (US); Dwight H. Damon, Spokane, WA (US)

(21) Appl. No.: 13/745,638

(22) Filed: Jan. 18, 2013

(51) Int. Cl. A61C 7/22; A61C 7/30

(52) U.S. Cl. CPC A61C 7/22; A61C 7/303
USPC 433/13; 433/16; 433/10

(57) ABSTRACT

An orthodontic bracket is described and which includes a bracket base which is releasably affixed to a patient's tooth; a bracket body borne on the bracket base and which defines a transversely disposed arch wire slot; and an arch wire received within the arch wire slot, and wherein the orthodontic bracket, acting in combination with the arch wire, is adjustable while affixed to the patient's tooth, to provide a multiplicity of selective torque and/or rotation expressions which individually, forcibly act upon the patient's tooth.

### TECHNICAL FIELD

The present invention relates to an orthodontic bracket, and more specifically to an orthodontic bracket which when used in combination with an arch wire, provides a multiplicity of selective torque expressions which individually forcibly act upon a patient's tooth.

### BACKGROUND OF THE INVENTION

Dr. Edward Angle, the father of modern orthodontics, invented the “Edgewise Appliance” and introduced it to the specialty in 1925. His design was a significant advancement in the treatment of patients by placing a mesio-distal horizontal rectangular slot in the bracket labial, and buccal surfaces thereby allowing clinicians to better position teeth. By bending round and/or rectangular arch wires and then placing them into these horizontal rectangular bracket slots, improved control of tooth position was achieved in three planes of space. Modern orthodontics has categorized these patient tooth movements into the three previously mentioned planes of space as first, second and third order movements.

Generally speaking, first order movements are commonly thought of as tooth rotation, and in/out tooth control. Further, second order movements are often referred to as “tipping” the root in a mesial and/or distal angulation, or elevation, and/or depression of a tooth position. Further, third order couples have resulted in the expression of “torque” which causes the axial inclination of a tooth from a flared or uprighted orientation to its final and desired position.

Heretofore, to achieve ideal tooth positioning, the clinician was required to bend round and rectangular shaped arch wires to express the in/out, up/down, tip, and torque to accomplish the final tooth position. This not only took long periods of time and advanced skills but it was nearly impossible to control the resulting treatment forces applied in all planes of space. As a result treatment times for patients were often long in duration, and the treatment forces which were applied often had a negative long term impact on the patient's bone and tissue.

In 1970, Dr. Larry Andrews invented what was later termed the “Straightwire Appliance.” This bracket design allowed significant improvements to first and second order tooth movements, and lessened the need for predetermined bending of the arch wires. However, this design still lacked adequate third order control of tooth axial inclination. The term “Straightwire Orthodontics” misled many clinicians to believe that only one bracket torque prescription on each anterior tooth was adequate to express a final desired tooth position. Unfortunately, without bending rectangular arch wires to individualize finishing torque on individual teeth, this had nearly the same effect as treating patients using only round arch wires in the bracket arch wire slot. This, of course negated any third order control. For example, if an 0.019 inch×0.025 inch stainless steel rectangular working or finishing arch wire is placed in a 0.022 inch arch wire slot, there is approximately 11 to 12 degrees of play, or freedom of movement, in either direction, for a total of 22 to 24 degrees of play or movement before a third order “torquing couple” is achieved between two opposite corners of the rectangular shaped arch wire, and the opposing walls of the bracket arch wire slot.

Over the years, some clinicians have tried to fill the arch wire slot with larger cross-sectional rectangular arch wires to achieve third order control, but many have found it difficult to finally position teeth due to the binding and friction which is experienced in the arch wire-bracket interface. The use of these larger dimensioned finishing rectangular arch wires also usually meant the application of unfavorable physical forces both in magnitude, and direction, which made final tooth position far more challenging for the clinician. This also resulted in a potentially negative, long term impact on the patient's bone and tissue. For this reason, most clinicians have tried to bend the appropriate amount of torquing couple into the smaller dimensioned rectangular arch wires to correctly procline or upright the axial inclination of the teeth to their final, and desired position.

It should be readily apparent that the multitude of variations which may impact third order tooth movements are many, and consequently orthodontist typically are not readily able, in a clinical setting, to accurately calculate the amount of third order movement that is needed, and the appropriate amount of force that might be needed or applied to a given tooth to achieve the desired movement. Consequently, because of miscalculation, treatment times for any given patient are often extended, as individual clinicians strive to achieve the desired tooth position, and alignment, which is appropriate.

Further, this miscalculation of the appropriate amount of force to express third order torque may result in excessive discomfort to the patient, and as previously mentioned, potentially negative long term periodontal health issues may arise for the orthodontically treated patient.

An adjustable orthodontic bracket which may be employed as a traditional tied active and/or passive self ligation arrangement, and which addresses these, and other shortcomings in current orthodontic appliance designs, and practices utilized heretofore, is the subject matter of the present application.

### SUMMARY OF THE INVENTION

A first aspect of the present invention relates to an orthodontic bracket which includes a bracket base which is releasably affixed to an anterior facing surface of a patient's tooth; a bracket body borne on the bracket base, and which further has an anterior facing surface which defines a transversely disposed, arch wire slot; and an arch wire received within the transversely disposed, arch wire slot, and wherein the orthodontic bracket, acting in combination with the arch wire, is adjustable while affixed to the anterior facing surface of the patient's tooth, and which provides a multiplicity of selective torque expressions which individually, forcibly act upon the patient's tooth.

Still another aspect of the present invention relates to an orthodontic bracket which includes a bracket base which is releasably affixed to an anterior facing surface of a patient's tooth; a bracket body mounted on the bracket base, and which has an anterior facing surface which defines a transversely disposed cavity; an arch wire insert having a main body which is defined by a longitudinal axis, and which is further received within the transversely disposed cavity, and wherein the main body further defines a transversely oriented arch wire slot, and wherein the arch wire insert is selectively rotatable about the longitudinal axis thereof; and an arch wire received within the transversely oriented arch wire slot, and which, acting in combination with arch wire insert, provides a multiplicity of selective torque expressions which individually forcibly act upon the patient's tooth.

Yet another aspect of the present invention relates to an orthodontic bracket which includes a bracket base which is releasably affixed to an anterior facing surface of a patient's tooth; a bracket body moveably cooperating with the bracket base, and wherein the bracket body has an anterior facing surface, and further defines a transversely disposed arch wire slot which communicates with the anterior facing surface of the bracket body; and an arch wire received within the transversely disposed arch wire slot, and wherein the moveable bracket body, acting in combination with the arch wire provides a multiplicity of torque expressions which individually, forcibly act upon the patient's tooth.

Still yet another aspect of the present invention relates to an orthodontic bracket which includes a bracket base which is releasably affixed to an anterior facing surface of a patient's tooth; a bracket body borne on the bracket base, and which further has a selectively adjustable transversely disposed arch wire slot; and an arch wire received within the selectively adjustable transversely disposed arch wire slot, and wherein the selectively adjustable transversely disposed arch wire slot, acting in combination with the arch wire, provides a multiplicity of selective torque expressions which individually, forcibly act upon the patient's tooth.

Moreover, still yet another aspect of the present invention relates to an orthodontic bracket which includes a bracket base which is releasably affixed to an anterior facing surface of a patient's tooth; a bracket body moveably cooperating with the bracket base, and wherein the anterior facing surface of the bracket body defines a transversely disposed arch wire slot which can be accessed through an aperture formed in the anterior facing surface of the bracket body; a gate moveably borne on the anterior facing surface of the bracket body, and which can reciprocally move along a path of travel from a first position, where access to the arch wire slot from the anterior facing surface of the bracket body is substantially unobstructed, to a second position, where the gate occludes the aperture formed in the anterior facing surface of the bracket body, and which further impedes access to the arch wire slot by way of the anterior facing surface of the bracket body; and an arch wire received within the transversely disposed arch wire slot, and which is further retained, therein, when the gate is located in the second position, and wherein the moveable bracket body, acting in combination with the arch wire, provides a multiplicity of torque expressions which individually, forcibly act upon the patient's tooth.

These and other aspects of the present invention will be described in greater detail hereinafter.

### BRIEF DESCRIPTION OF THE DRAWINGS

Preferred embodiments of the invention are described below with reference to the following accompanying drawings.

FIG. 1 is a transverse, vertical, sectional view of one form of the orthodontic bracket of the present invention.

FIG. 2 is a transverse, vertical, sectional view of the present invention as seen in FIG. 1, and which is shown in a first operational position.

FIG. 3 is a transverse, vertical, sectional view of the invention as seen in FIG. 1, and which is shown in a second operational position.

FIG. 4 is a greatly enlarged transverse, vertical, sectional view of an arch wire insert which finds usefulness in the form of the invention as seen in FIG. 1.

FIG. 5 is a side elevation view of an arch wire insert which finds usefulness in the form of the invention as seen in FIG. 1.

FIG. 6 is a transverse, vertical, sectional view of another form of the orthodontic bracket of the present invention.

FIG. 7 is a top, plan view of the form of the invention as seen in FIG. 6.

FIG. 8 is a transverse, vertical, sectional view of the orthodontic bracket as seen in FIG. 6, in a first operational position.

FIG. 9 is a transverse, vertical, sectional view of the invention as seen in FIG. 6, but illustrated in a second operational position.

FIG. 10 is a transverse, vertical, sectional view of the form of the invention as seen in FIG. 6, but which is illustrated in yet another, third, operational position which is different from that seen in FIG. 6 or 7, respectively.

FIG. 11 is a greatly enlarged, exploded, side elevation view of yet another form of the orthodontic bracket of the present invention, and which shows the bracket body in a first operational condition.

FIG. 12 is a second, greatly enlarged, exploded, side elevation view of the form of the invention as seen in FIG. 11, and which further illustrates the bracket body in a second, operational condition.

FIG. 12A is a partial, side elevation view of an alternative form of an axle receiving member which is useful in the present invention.

FIG. 13 is a greatly enlarged, exploded, side elevation view of yet another form of the invention, and which further illustrates the bracket body in a first operational condition.

FIG. 14 is a greatly enlarged, exploded, side elevational view of the form of the invention as seen in FIG. 13, and which illustrates the bracket body in a second operational condition.

FIG. 15 is a side elevation view of the form of the invention as seen in FIG. 13, and which is illustrated in a first operational position.

FIG. 16 is a side elevation view of the form of the invention as seen in FIG. 13, and which is shown in a second operational position.

FIG. 17 is a side elevation view of yet another form of the orthodontic bracket of the present invention.

FIG. 18 is a greatly enlarged, top, plan view of a locking member which finds usefulness in the form of the invention as seen in FIG. 17.

FIG. 18A is a side elevation view of the locking member as illustrated in FIG. 18.

FIG. 19 is a greatly enlarged, side elevation view of the form of the invention, and as seen in FIG. 17, and which is illustrated in a first operational condition.

FIG. 20 is a greatly enlarged, side elevation view of the form of the invention as seen in FIG. 17, and which illustrates the invention in yet another operational condition.

FIG. 21 is an exploded, greatly enlarged, end view of an arch wire insert which finds usefulness in the form of the invention as seen in FIG. 17.

FIG. 22 is an exploded, greatly enlarged, side elevation view of the arch wire insert which finds usefulness in the form of the invention as seen in FIG. 21.

FIG. 23 is a side elevation view of yet another form of the orthodontic bracket of the present invention.

FIG. 24 is a top plan view of a locking member which finds usefulness in the form of the invention as seen in FIG. 23.

FIG. 25 is a side elevation view of the locking member as illustrated in FIG. 24.

FIG. 26 is a greatly enlarged, side elevation view of the form of the invention as seen in FIG. 23, and which is illustrated in a first operational condition.

FIG. 27 is a greatly enlarged, side elevation view of the form of the invention as seen in FIG. 26, and which is illustrated in a second operational condition.

FIG. 28 is a greatly enlarged, side elevation view of an arch wire insert which finds usefulness in the form of the invention as seen in FIG. 23.

FIG. 29 is an end view of the arch wire insert as seen in FIG. 28.

FIG. 30 is a top plan view of yet another form of the orthodontic bracket of the present invention.

FIG. 31 is a side elevation view of a rotation adjustment member which finds usefulness in the form of the invention as seen in FIG. 30.

FIG. 31A is a top plan view of one form of the rotation control member as seen in FIG. 31.

FIG. 31B is a top plan view of another form of the rotation control member as seen in FIG. 31.

FIG. 31C is a top plan view of yet another form of the rotation control member as seen in FIG. 31.

FIG. 32 is a top plan view of the orthodontic bracket as seen in FIG. 30 in a first operational condition.

FIG. 33 is a top plan view of the orthodontic bracket as seen in FIG. 30, and which is illustrated in a second operational condition.

FIG. 34 is a top plan view of the orthodontic bracket as seen in FIG. 30, and which is illustrated in a third operational condition.

FIG. 35 is a side elevation view of an arch wire insert which finds usefulness in the invention as seen in FIG. 30.

FIG. 35A is top plan view of a second version of the orthodontic bracket as seen in FIG. 30.

FIG. 36 is an end view of an arch wire insert which finds usefulness in the form of the invention as seen in FIG. 30.

FIG. 37 is a side elevation view of yet another form of the present invention and which is illustrated with the gate employed with same, removed, so as to show the structure thereunder.

FIG. 38 is a top, plan view of a locking member which finds usefulness in the form of the invention as seen in FIG. 37.

FIG. 39 is a side elevation view of a bracket base which finds usefulness in the form of the invention as seen in FIG. 37. Some underlying surfaces are illustrated in phantom lines.

FIG. 40 is a top plan view of the orthodontic bracket as seen in FIG. 37. Again, some underlying structures are shown in phantom lines.

FIG. 41 is a side elevation view of yet another form of the orthodontic bracket of the present invention, and showing some underlying surfaces in phantom lines.

FIG. 42 is a side elevation view of the orthodontic bracket as seen in FIG. 41 and which is shown in a first operational position.

FIG. 43 is a side view of a disassembled orthodontic bracket as seen in FIG. 41.

FIG. 44 is a perspective, anterior view of the orthodontic bracket structure as seen in FIG. 43.

FIG. 45 is a side elevation view of an arch wire insert, which finds usefulness in the orthodontic bracket as seen in FIG. 41.

FIG. 45A is a transverse, vertical, sectional view taken from a position along line 45A-45A of FIG. 45.

FIG. 45B is a transverse, vertical, sectional view taken from a position along line 45B-45B of FIG. 45.

FIG. 45C is a transverse, vertical, sectional view taken from a position along line 45C-45C of FIG. 45.

FIG. 46 is a side elevation view of the base portion of still another form of the orthodontic bracket of the present invention.

FIG. 47 is a top plan view of a bracket body, which finds usefulness with the structure as seen in FIG. 46.

FIG. 48 is a top plan view of the bracket base as seen in FIG. 46.

FIG. 49 is an anterior, side elevation view of the bracket body as seen in FIG. 47.

FIGS. 49A and B are side elevation views of locking members, which find usefulness with the bracket body as seen in FIG. 49.

FIG. 50 is an anterior, side elevation view of the bracket base as seen in FIG. 46.

FIG. 51 is a top, plan view of one form of the orthodontic bracket and which is shown in an assembled arrangement.

FIG. 52 is a side elevation view of the orthodontic bracket as seen in FIG. 51, and which is illustrated in a first operational position.

FIG. 53 is a side elevation view of the orthodontic bracket as seen in FIG. 51 and which is illustrated in a second operational position.

FIG. 54 is a side elevation view of the orthodontic bracket as seen in FIG. 51 and which is illustrated in a third operational position.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

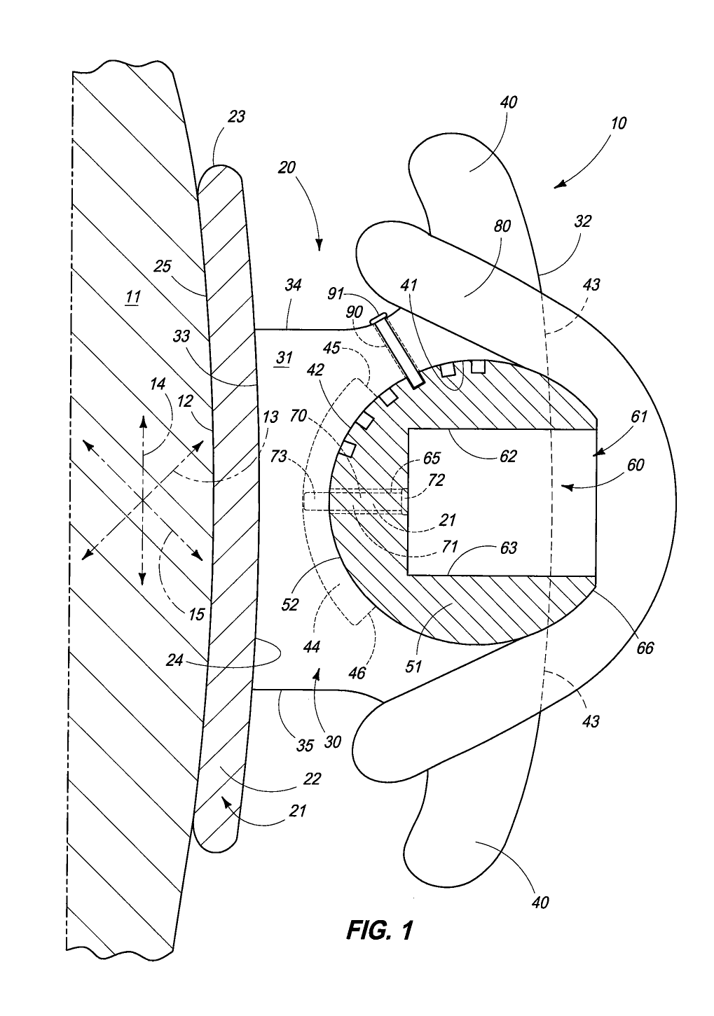

The present invention is generally indicated by the numeral 10 in FIG. 1 and following. For purposes of the present application, it will be understood that common, repeated numerals, refer to similar structures in the various forms of the invention as disclosed, hereinafter. To appreciate the novelty of the present invention, it should be understood that the orthodontic bracket 10 of the present invention is employed to be releasably affixed on a patient's tooth 11, and in particular, the anterior facing surface 12 thereof. The orthodontic bracket, 10 in combination with the arch wire as will be described, hereinafter, is employed to provide a multiplicity of selective torque expressions which individually, forcibly, act upon the patient's tooth 11. For purposes of this patent application, the term “torque expression” as used hereinafter is defined as the force moment providing rotation of a patient's tooth around the x-axis (buccal-lingual). In particular, the orthodontic bracket 10 of the present invention can be employed to achieve first, second and third order movements, that is, 13, 14, and 15, respectively as seen in FIG. 1 without clinically predetermined manipulation, bending, twisting, or rotation of the rectangularly shaped arch wire, or the often repeated replacement of this arch wire during the orthodontic treatment period. The present invention 10 provides a novel means by which a clinician can readily shorten patient treatment times, and also achieve superior treatment results, and increased patient comfort, in a manner not possible, by utilizing the prior art appliances or practices.

### First Form of the Invention

As earlier discussed in this application, tooth movement is defined relative to three planes in space. In this regard, movements in these respective planes are categorized as first order, second order and third order 13, 14 and 15, respectively (FIG. 1). First order movements 13 are commonly thought of as rotation and/or, in and out movements. This refers to movements that can be viewed from the occlusal perspective. On the other hand, second order movements, and which are often referred to as “tipping” can be viewed from a buccolingual or a labiolingual perspective. These include movements in the occlusogingival direction, or tipping about the buccolingual or labiolingual axis. As a general matter, rotation about the aforementioned axis would typically result in tipping of the root or crown in a mesial or distal direction. These second order movements are used for paralleling of the roots of the respective teeth, as well as elevating or depressing a given tooth. Finally, third order movements 15 are commonly thought of as “torque” and can be viewed from a mesial distal perspective or a buccolingual cross-section. Third order movements typically refer to movements about a mesial distal axis. This particular movement is often important when attempting to achieve proper incisor or buccoaxial inclination. First, second and third order movements are best seen by reference to FIG. 1, and are indicated by the numerals 13, 14 and 15, respectively.

The first form of the invention is generally indicated by the numeral 20 in FIGS. 1-5. In this regard, the first form of the invention includes a bracket base, including a pad 21, and which is suitably affixed by an adhesive, not shown, to the anterior facing surface 12 of the patient's tooth 11. The bracket base has a main body 22, which is defined by a peripheral edge 23. Still further, the bracket base 21 has an anterior facing surface 24, and an opposite, posterior facing surface 25, which is adhered or otherwise affixed to the anterior facing surface 12 of the patient's tooth 11. Still further, and as seen in the drawings, the first form of the invention 20 includes a bracket body 30 which is either affixed to, or made integral with, the bracket base 21. The bracket body 30 has a main body 31 which extends generally anteriorly, outwardly relative to the anterior facing surface 24 of the bracket base 21. Still further, the main body 31 also defines a superior or top surface 34, and an opposite, inferior, or bottom surface 35.

As seen in the drawings (FIGS. 1-3), the first form of the invention 20, and more specifically the bracket body 30 includes opposed tie wings which are generally indicated by the numeral 40. The tie wings extend, on the one hand, either superiorly, upwardly, or on the other hand inferiorly, downwardly, from the main body 31 as illustrated. Additionally, the bracket body 30 defines a transversely disposed cavity 41, which is generally cylindrical in shape, and which is defined, at least in part, by a generally cylindrically shaped sidewall 42. The transversely disposed cavity 41 is defined, at least in part, by an aperture 43, which is formed in the anterior facing surface 32, of the bracket body 30, and which has a predetermined cross-sectional dimension. Moreover, and as seen in the drawings, an elongated, substantially arcuately shaped engagement channel 44 is formed in the bracket body 30, and which communicates with the transversely disposed cavity 41, and which further extends substantially along a vertical plane relative to the bracket body 30. The elongated engagement channel 44, has a first end 45, and an opposite second end 46.

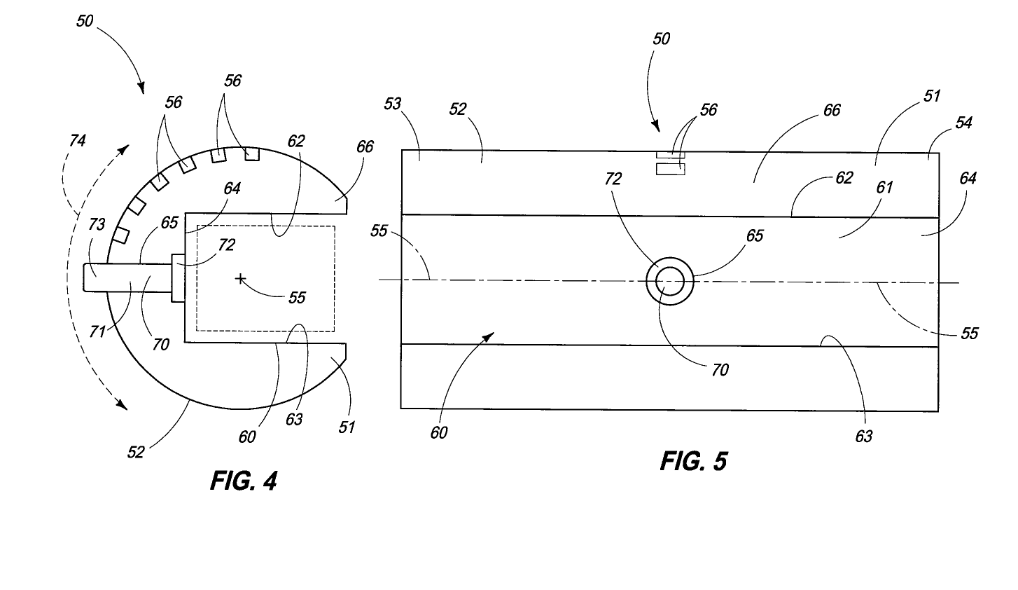

As seen in the drawings (FIGS. 4 and 5), the first form of the invention 20 includes an arch wire insert 50, which has a main body 51, and which is further defined, in part, by an exterior facing surface 52, and which is cylindrically shaped, and which further is sized so as to be telescopingly received within the transversely disposed cavity 41, which is defined by the bracket body 30. The main body 51 of the arch wire insert 50 further has a first end 53, and a second end 54. The main body 51 is further defined by a longitudinal axis 55, and is further, selectively, partially rotatable thereabout the longitudinal axis 55, and along a given path of travel, and which will be discussed in greater detail, hereinafter. As seen in the drawings, a multiplicity of spaced, engagement or locking channels 56 are formed in the exterior facing surface 52.

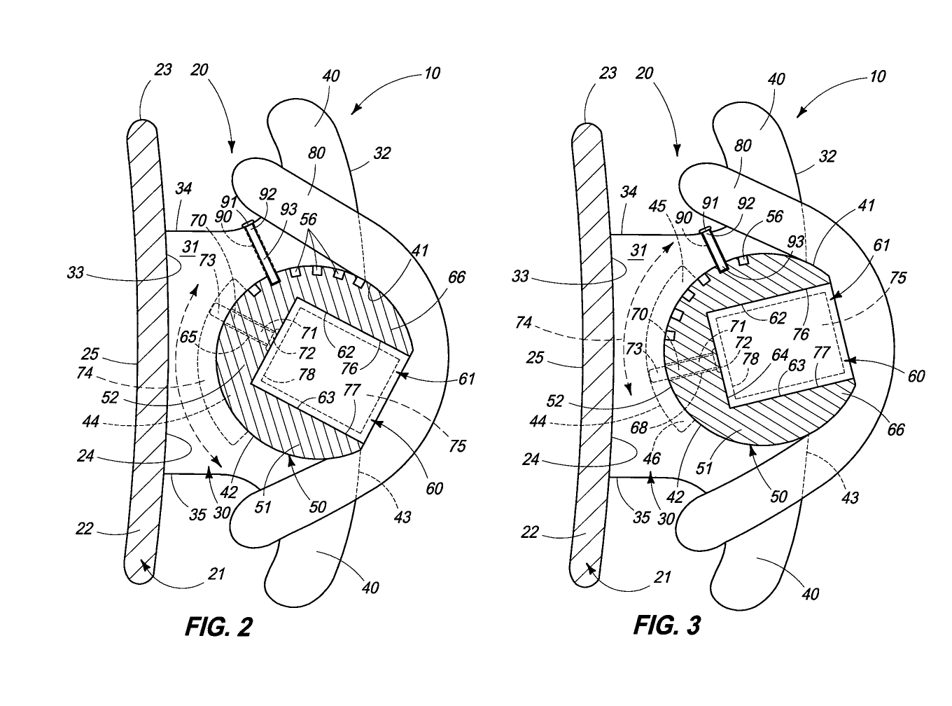

The first form of the orthodontic bracket 20 of the present invention 10, as noted above, includes an arch wire insert 50. The arch wire insert 50 defines a transversely disposed and rectangularly shaped arch wire slot which is generally indicated by the numeral 60. The transversely disposed arch wire slot 60 is defined, in part, by an opening 61 which is formed in the exterior facing surface 52 of the main body 51. The arch wire slot 60 extends from the exterior facing surface 52, and in the direction of the longitudinal axis 55 thereof. The opening 61 has a cross-sectional dimension which is less than the cross-sectional dimension of the aperture 43 which is formed in the anterior facing surface 24 of the bracket body 30, as earlier discussed. As illustrated in the drawings, the transversely disposed arch wire slot 60, which is generally rectangularly shaped, is also defined, at least in part, by opposed superior, and inferior facing surfaces 62 and 63, respectively, and which are individually oriented in substantially predetermined, spaced, parallel relation, one relative to the other. Still further, the transversely disposed arch wire slot 60 includes a rear wall 64 which extends between the opposed, superior, and inferior, facing surfaces 62 and 63, respectively, and which is further located posteriorly, inwardly, relative to the outside or exterior facing surface 52 of the main body 51 of the arch wire insert 50. Additionally, and as will be seen in FIG. 4, a passageway 65 is formed in the arch wire insert, and which extends generally in a radial direction between the rear wall 64 of the arch wire slot 60, to the exterior facing surface 52, of the main body 51. The passageway 65 is transversely oriented relative to, and directly communicates with, the elongated engagement channel 44 which is formed in the bracket body 30, as was discussed in the paragraphs, above. Additionally, and as seen in the drawings (FIGS. 1 and 2), the main body 51, of the arch wire insert 50 includes a portion 66 of the exterior facing surface 52, and which extends outwardly through the aperture 43, and which is defined by the bracket body 30. This portion 66 is located anteriorly, outwardly, relative to the anterior facing surface 32, of the bracket body 30.

In the first form of the invention 20, as illustrated, the arch wire insert 50 is generally rotatable about the longitudinal axis 55. The arch wire insert 50, and more specifically the main body 51, thereof, is retained, or otherwise secured within the transversely disposed cavity 41, by means of a first engagement member or retaining pin 70. The first engagement member or retaining pin 70 is elongated in shape, and has a main body 71. The main body 71 has an enlarged, proximal end 72, and a distal end 73. The distal end of the engagement member or retaining pin 70 is received within the elongated, arcuately shaped engagement channel 44 which is formed in the bracket body 30. The engagement member or retaining pin substantially moveably fixes or retains the orientation of the arch wire insert 50 within the transversely disposed cavity 41 as defined by the bracket body 30. Still further, the first engagement member 70, when received within the elongated engagement channel 44, provides a means by which the arch wire insert 50 is rendered selectively, moveably rotatable along a path of travel 74, and in a range of movement of less than about 60 degrees relative to the bracket body 30. In this regard, it will be appreciated from a study of FIGS. 1 and 2, that the distal end 73, of the first engagement member 70 defines the path of travel 74, as the distal end 73 engages the opposite, first and second ends 45 and 46 respectively, of the elongated engagement channel 44. The path of travel 74, which is defined by the cooperation of the first engagement member or retaining pin 70, with the channel 44, ensures that the opening 61 is never occluded, in part, by the anterior facing surface 32 of the bracket body 30. Therefore, the opening 61 of the arch wire slot 60 is exposed while moving along the path of travel 74, so as to effectively receive the arch wire therein. Further, and by the selective rotation of the arch wire insert 50, and which further acts upon the rectangular shaped arch wire, as will be described, hereinafter, and which further is received in the arch wire slot 60, the arch wire insert 50 achieves predetermined first, second and third orders of movements 13, 14, and 15, respectively, of the patient's tooth 11, as earlier disclosed. The arch wire 75, which is employed with the invention 10, is of conventional design, and has a rectangular shape. The arch wire has a top or superior facing surface 76, and an opposite, or inferior facing surface 77. Further, the rectangular shaped arch wire 75 has side walls 78. In the present form of the invention 20, the invention provides a novel means for achieving first, second and third order movements of a patient's tooth 11 without replacing or a substitution of the rectangular shaped arch wire 75, or further, without a clinically predetermined manipulation of the arch wire 75 (such as deliberate, calculated bending or twisting), and which is then received in the transversely disposed arch wire slot 60. As earlier noted, this feature of the invention allows a clinician to shorten treatment times, and gives greater comfort to the patient because the repeated replacement of arch wires during the treatment of the patient is reduced or even eliminated. Moreover, the present invention allows a lighter force arch wire to be employed. This causes the patient to experience greater comfort during treatment.

As seen in the drawings, and in the first form of the invention 20, a traditionally designed ligature 80, such as an elastic band; a flexible wire, or the like, is utilized, and which is operable to engage the respective tie wings 40 which are made integral with the bracket body 30. The ligature 80 is operable to frictionally engage the portion 66 of the main body 51 of the arch wire insert 50, and which extends posteriorly, outwardly relative to the anterior facing surface 32 of the bracket body 30. Additionally, and as seen in the drawings, and in this first form of the invention 20, a second passageway 90 is formed in the main body 31, and which extends from the superior or top surface 34, and in the direction of, and couples to, or connects with, the transversely disposed cavity 41. The second passageway 90 is operable to receive, in the nature of a friction-fit, a second engagement or locking member 91. The second engagement or locking member 91 has a proximal end 92, and a distal end 93. The second engagement or locking member 91, and more specifically the distal end 93, thereof, is used to frictionally, or otherwise matingly engage, both the rotatable arch wire insert 50, and the bracket body 30, in a fashion so as to selectively, rotatably secure or otherwise fix the arch wire insert 50 in a predetermined position or orientation along the path of travel 74, so as to provide a clinician a multiplicity of selective torque expressions which can individually, forcibly act upon the patient's tooth 11, as earlier described. As seen in the drawings, the distal end 93 is typically received in one of the multiplicity of spaced engagement or locking channels 56 which are formed in the exterior facing surface 52. As will be appreciated, the ligature 80, which is provided, is operable to retain the rectangularly shaped arch wire 75 within the transversely disposed and rectangularly shaped arch wire slot 60.

Therefore, one aspect of the present invention relates to an orthodontic bracket 20 which has a bracket base 21, and which is further releasably affixed to the anterior facing surface 12 of the patient's tooth 11. The bracket body 30 is mounted on, or made integral with, the bracket base 21, and further defines a transversely disposed cavity 41. An arch wire insert 50 is provided, and which is defined by a longitudinal axis 55, and which is further received within the transversely disposed cavity 41. The main body 51 of the arch wire insert 50 further defines a transversely oriented arch wire slot 60. Further, the arch wire insert 50 is selectively rotatable about the longitudinal axis 55. An arch wire 75 is provided, and is placed within the transversely oriented and rectangularly shaped arch wire slot 60. The arch wire insert, acting in combination with the rectangularly shaped arch wire 75, provides a multiplicity of selective torque expressions 13-15, respectively, and which individually forcibly act upon the patient's tooth 11 (FIG. 1).

### Second Form of the Invention

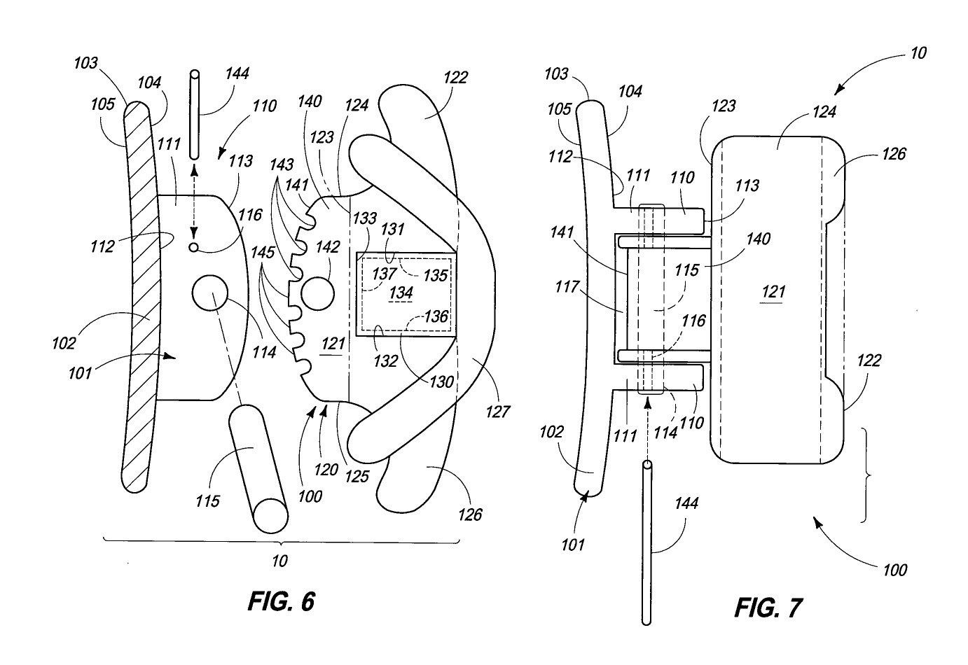

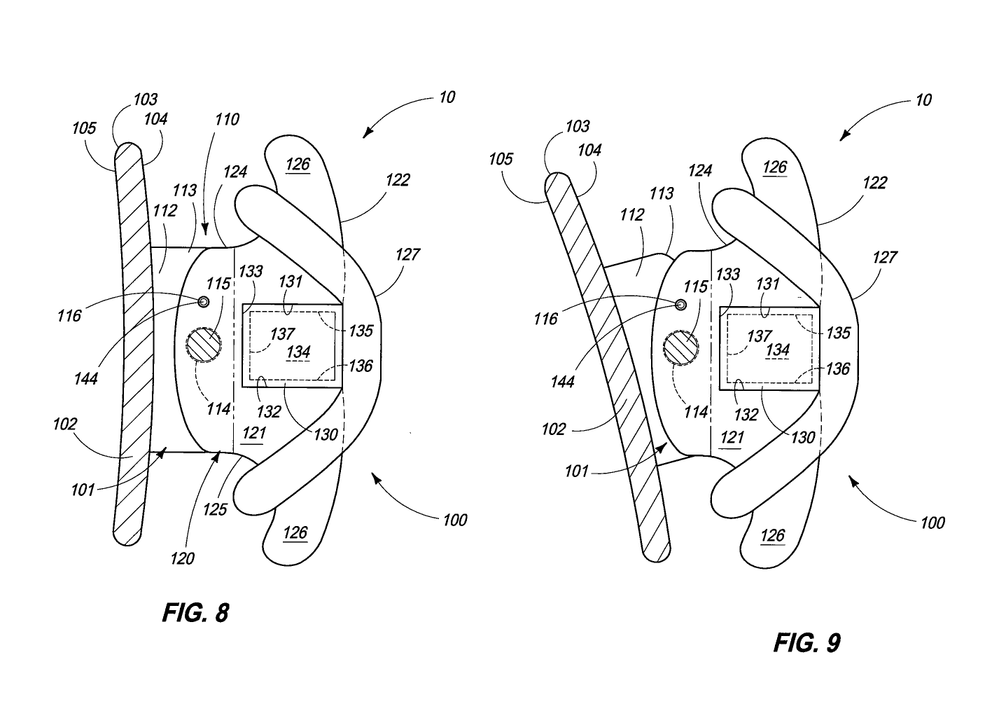

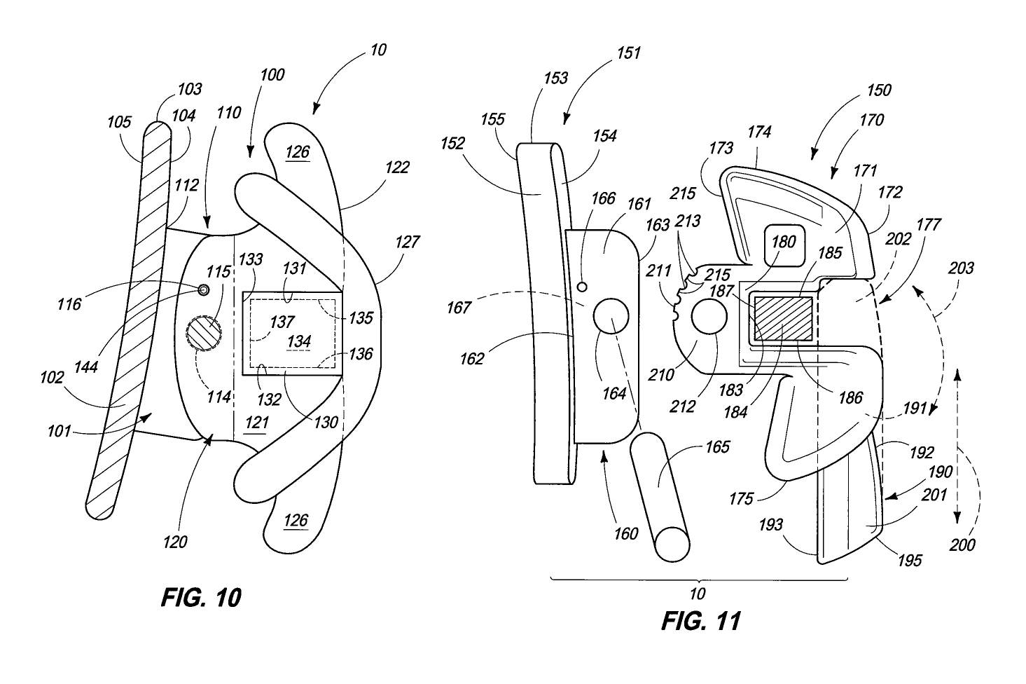

A second form of the invention 10, is illustrated in the drawings (FIGS. 6-10), and is generally indicated by the numeral 100. The second form of the invention 100, and which is similar to that described with the first form of the invention 20, has a bracket base 101. The bracket base 101, has a main body 102, and which is defined, at least in part, by a peripheral edge 103. The main body 102 further has an anterior facing surface 104, and an opposite, posterior facing surface 105, which is typically adhesively affixed to the anterior facing surface 12, of the patient's tooth 11.

Extending generally, anteriorly, outwardly, and substantially normally relative to the bracket base 101, of the second form of the invention 100, is a pair of spaced, support members 110 (FIG. 7). The pair of spaced support members 110 are each defined by a main body 111, and which further have a first, inwardly or posteriorly oriented edge 112. The posterior oriented edge 112 is either mounted on, or made integral with, the anterior facing surface 104 of the bracket base. Additionally, each of the individual support members 110 further has a second, anterior, or outwardly facing edge 113 which, in this form of the invention, assumes a substantially curved shape as seen in FIG. 6. Moreover, each of the spaced support members 110 has a first passageway 114 formed therein. The first passageway 114 of each of the individual, spaced, support members 110, are coaxially aligned. This coaxial alignment facilitates the receipt of an axle 115 therein. The axle 115 is spaced a predetermined distance from the anterior facing surface 104 of the bracket base 101. As should be understood from a study of the drawings, a gap 117 is formed between the pair of spaced support members 110. This gap has predetermined width dimensions. The pair of spaced support members 110 are disposed in substantially parallel, spaced relation, one relative to the other. Still further, and as seen in the drawings, a second passageway 116 is formed in predetermined spaced, relation relative to the first passageway 114. The second passageway 116 is operable to receive, and releasably cooperate with, a locking member as will be discussed in greater detail, in the paragraphs which follow.

The second form of the invention 100 includes a rotatable bracket body which is herein indicated by the numeral 120. The bracket body is defined, at least in part, by a main body 121 having an anterior facing surface 122, and an opposite, posterior facing surface 123. Still further, the main body 121 has a superior, or upper facing outside surface 124, and an opposite, and lower, inferior facing surface 125. The invention 100 includes tie wings 126 of conventional design, and which extend both superiorly, upwardly, and inferiorly, downwardly relative to the main body 121, and are operable to be engaged by a ligature 127 of traditional design.

The bracket body 120 defines a transversely disposed, rectangularly shaped, arch wire slot 130 which extends inwardly relative to the anterior facing surface 122, of the main body 121. The transversely disposed and rectangularly shaped arch wire slot 130 is defined by superior and inferior facing surfaces 131 and 132, respectively, and which are disposed in predetermined, substantially parallel, spaced relation, one relative to the other. Still further, the transversely disposed arch wire slot 130 is defined, in part, by an inwardly or posteriorly positioned sidewall 133, and which joins the superior and inferior facing surfaces 131 and 132, together. The transversely disposed arch wire slot 130 receives, and cooperates with a rectangular shaped arch wire 134 of traditional design. Again, the arch wire 134 has superior and inferior facing surfaces 135 and 136, respectively, and which allows it to be received within the transversely disposed arch wire slot 130. Still further, the arch wire 134 is defined by opposite sidewalls 137. Again, in the second form of the invention 100, the bracket body 120, acting upon the arch wire 134, can be selectively rotated to a predetermined orientation so as to effect first, second and third order movements 13, 14, and 15 of the patient's tooth 11 by utilizing the same arch wire 134. The arch wire 134 is retained within the transversely disposed arch wire slot 130, by means of the ligature 127 in a traditional fashion. This novel structure, therefore, allows a given orthodontic treatment plan to proceed rather expeditiously because a clinician no longer needs to repeatedly replace arch wires as often while a predetermined orthodontic treatment plan continues. Further a clinician can now achieve the desired third order control with lighter, and smaller dimensioned rectangular arch wires without the deliberate bending and manipulation of the arch wire which is now the common practice among clinicians.

The second form of the invention 100 includes an axle receiving member 140 which is affixed on, and which extends posteriorly, rearwardly relative to, the posterior facing surface 123 of the bracket body 120. The axle receiving member 140 has a given width dimension which is less than the width dimension of the gap 117, and which is defined between the pair of spaced support members 110. Still further, the axle receiving member 140 is defined by a curvy-linear shaped peripheral edge 141. Still further, an axle passageway 142 is formed through the axle receiving member 140, and is operable to receive the axle 115 which is supported by the pair of spaced support members 110. By means of the axle passageway 142, the bracket body 120 is rotatable thereabout the axle 115, and in a substantially vertical plane so as to achieve the benefits of the present invention. As illustrated, a multiplicity of semi-circular engagement apertures 143 are formed in spaced relation along the peripheral edge 141. The individual semi-circular shaped engagement apertures 143 are oriented in a spaced fashion, one relative to the others, such that they may be individually, selectively coaxially aligned, at least in part, with the second passageway 116 which is formed in one of the pair of spaced support members 110. When coaxially aligned, an engagement or locking member 144 may be received, therethrough, thereby fixedly positioning or orienting the bracket body 120 in a given rotational orientation relative to the bracket base 101 in order to achieve the benefits of the invention which include providing an orthodontic bracket 100 which, when acting upon the rectangularly shaped arch wire, provides multiple torque expressions which individually forcibly act on the patient's tooth 11. As seen in the drawings, the curvy-linear shaped peripheral edge 141 includes regions, or portions 145, that are defined between the respective semi-circular engagement apertures 143, and which are substantially linear or flat in shape or profile. Depending upon the rotational orientation of the bracket body 120, the individual linear portions 145 can be located or positioned in predetermined, substantially parallel, spaced relation relative to the bracket base 101, and thus provide a means whereby the engagement or locking member 144 may be wedged, or otherwise lodged, or placed, therebetween one of the linear portions 145, and the adjacent spaced bracket body 120. When this placement of the locking member 144 is achieved, it is effective in substantially preventing further bracket body 120 rotational movement about the axle 115. In this fashion, a clinician can readily, and almost continuously, rotatably adjust the rotatable angular orientation of the bracket body 120 relative to the bracket base 101 to achieve first, second and third order movements of the patient's tooth by utilizing the same rectangularly shaped arch wire 134 that has been employed in earlier phases of the orthodontic treatment regimen. Still further, this and the other forms of the invention as disclosed herein, provide a convenient, and novel means whereby a clinician can utilize a lighter force arch wire, but by the selective adjustment of the bracket body, can readily implement first, second and third order movements without continuously changing the size or dimensions of the rectangular arch wire, (thus shortening patient treatment times). Further, by utilizing lighter weight or lighter forces on the patient's tooth 11, a clinician minimizes the potential for negative impact on the patient's tooth and tissue. Additionally, the use of the several forms of the orthodontic bracket as disclosed, provides greater patient comfort during the orthodontic treatment regimen because lighter force rectangular arch wires can be utilized to achieve first, second, and in particular, third order control of a patient's teeth.

### Third Form of the Invention

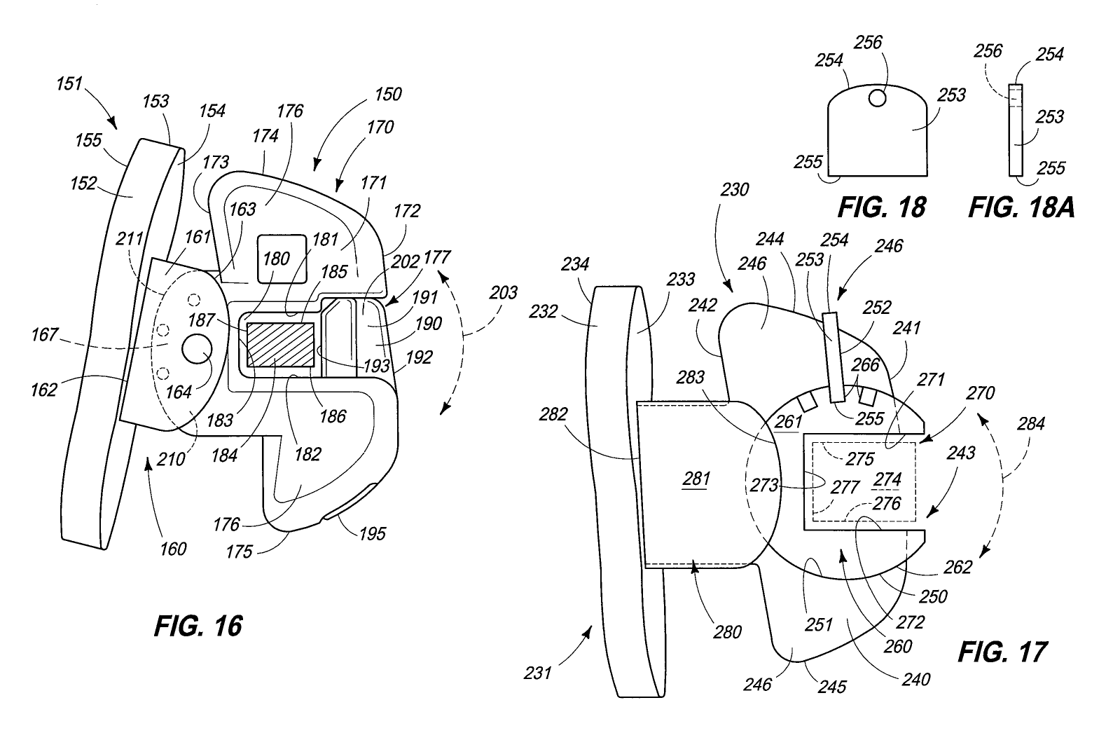

A third form of the invention is generally indicated by the numeral 150, and is seen in FIGS. 11-16, respectively. As illustrated, the third form of the invention 150 includes a bracket base which is generally indicated by the numeral 151, and which is secured on the anterior facing surface 12 of a patient's tooth 11. Typically, this bracket base 151 is secured by a suitable adhesive or other means well known in the art. The bracket base has a main body 152 which is defined, in part, by an outside peripheral edge 153. Still further, the main body 152 has an anterior facing surface 154, and an opposite, posterior facing surface 155 which is affixed to the anterior facing surface 12 of the patient's tooth 11. The bracket base 151 further includes a pair of spaced support members 160 which are affixed on, or made integral with the bracket base 151. The respective pair of spaced, substantially parallel support members 160 have a main body 161 which has a first posterior facing edge 162 and which is mounted on, or made integral with, the anterior facing surface 154. Further, the main body 161 has a second, anterior facing edge 163, as illustrated. Additionally, and as seen in the drawings, a first passageway 164 is formed in each of the pair of spaced support members 160. The first passageway 164, of each of the pair of spaced support members, are substantially coaxially aligned, and are sized so as to receive an axle 165 therethrough. Additionally, and as seen in FIG. 11, for example, a second, smaller passageway 166 is formed in at least one of the pair of spaced support members 160, and which is located in predetermined spaced relation relative to the first passageway 164. As can be appreciated from the drawings, a gap 167 is defined between the anterior facing surface 154 of the bracket base 151, and the axle 165 which is received through the coaxially aligned first passageway 164.

The third form of the invention 150 includes a bracket body 170. The bracket body has a main body 171, and which is rotatably mounted to the bracket base 151. The bracket body 170 further has an anterior facing surface 172, and a posterior facing surface 173. Additionally, the main body 171 has both superior and inferior facing surfaces 174 and 175, respectively. As discussed with the earlier forms of the invention, the bracket body 170 includes traditional tie wings 176 which extend generally superiorly, upwardly, or inferiorly, and downwardly relative to the main body 171 as illustrated.

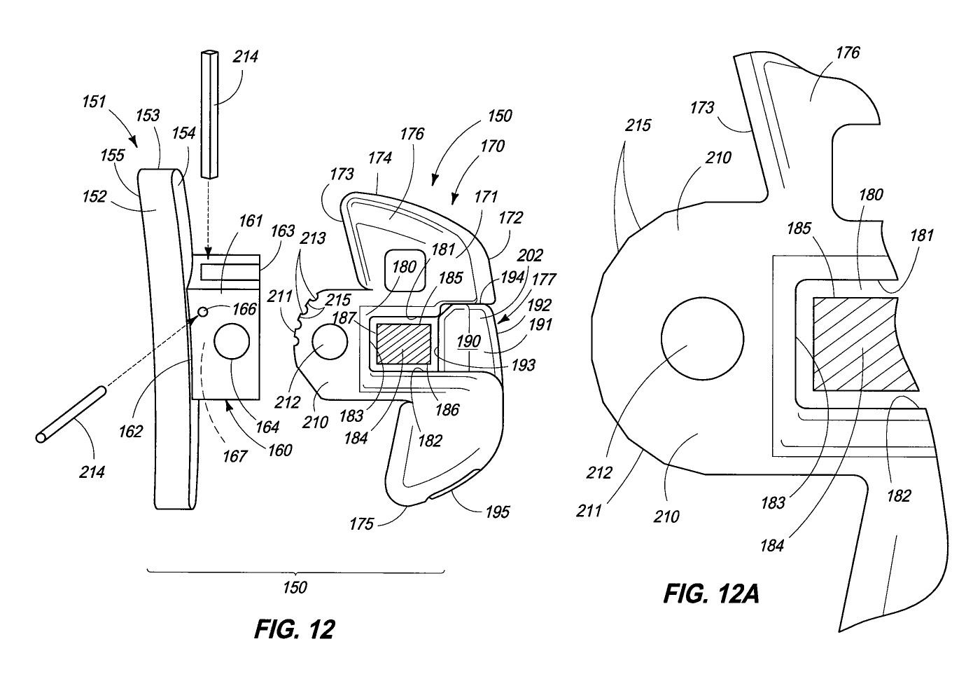

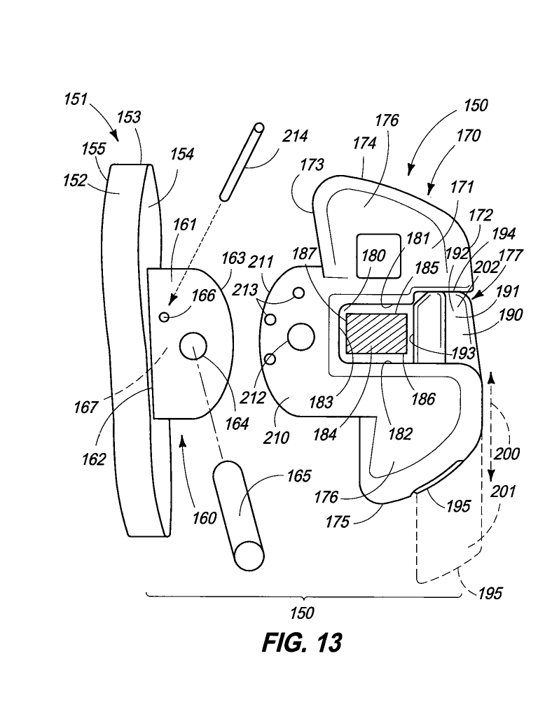

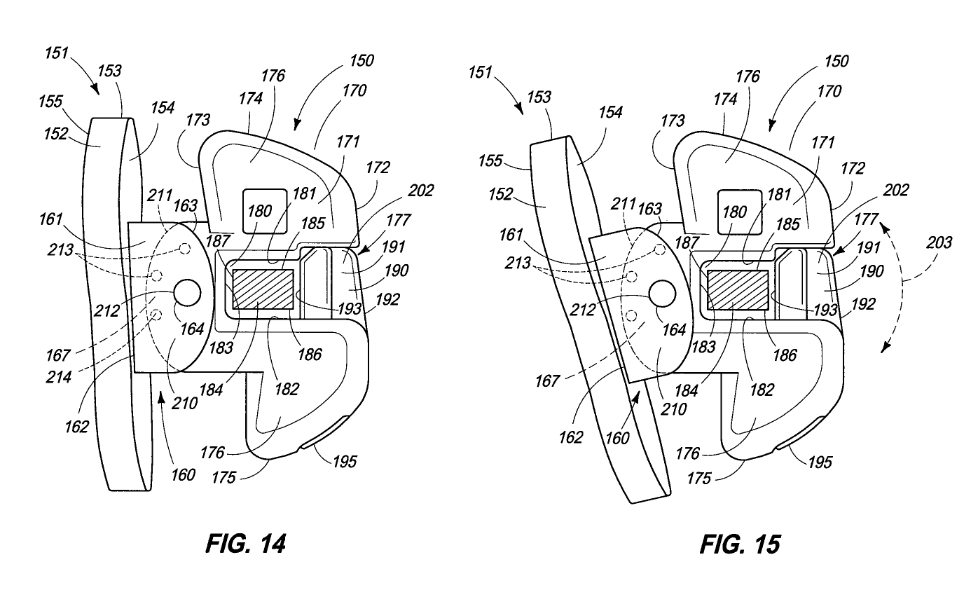

As seen in FIG. 11 and following, the bracket body 170 has an aperture 177 which is formed in the anterior facing surface 172, and which leads to a rectangularly shaped arch wire slot 180 which is substantially transversely disposed, or otherwise formed in the bracket body 170. The arch wire slot 180 is defined by opposed, and spaced, superior and inferior facing surfaces 181 and 182, respectively. The superior and inferior facing surfaces 181 and 182 are joined together by an inwardly oriented, and posteriorly positioned sidewall 183 which joins to same. As seen in the drawings, and as earlier discussed, a rectangular shaped arch wire of conventional design 184 is received within the rectangularly shaped arch wire slot 180. The arch wire has superior, and inferior facing surfaces 185 and 186, and is further defined by sidewalls 187 which connect to the superior and inferior facing surfaces. The arch wire 184 is captured or otherwise received within the arch wire slot 180 by means of a moveable gate, here indicated by the numeral 190. The gate 190 is formed of a main body 191 which has an anterior facing surface 192, and an opposite, posterior facing surface 193. The main body further has a superior or top edge 194, and an opposite inferior or bottom edge 195. By applying force to the anterior facing surface 192, a clinician is able to move the gate 190 along a path of travel 200 between a first position 201, (FIG. 13) where access to the arch wire slot 180 from the anterior facing surface 177 of the bracket body 170 is substantially unobstructed, to a second position 202 (FIG. 14), where the gate 190 occludes the aperture 177 which is formed in the anterior facing surface 172 of the bracket body 170, and which further impedes access to the arch wire slot 180 by way of the anterior facing surface 172 of the bracket body. As seen in FIG. 11, the gate 190 is shown in the first, down position 201, and in FIG. 12, the gate 190 is shown in the second or up position 202. As seen in the drawings, the bracket body 170 is selectively rotatable along a substantially vertically disposed path of travel 203, and within a range of movement which is less than about 60 degrees relative to the bracket base 151. This allows a clinician to appropriately position the bracket body 170 in a predetermined location where the bracket body, acting in combination with the arch wire 180, provides a multiplicity of torque expressions which individually forcibly act upon the patient's tooth 11.

As illustrated in FIGS. 11, 12, 12A and following, the third form of the invention 150 includes an axle receiving member 210 which is mounted on, or made integral with the bracket body 170, and which extends posteriorly, rearwardly relative thereto. The axle receiving member 210 has a posterior facing peripheral edge 211 which has an axle passageway 212 which is formed therein. The axle passageway 212 is operable to receive the axle 165 therein, and which renders the bracket body moveable along the path of travel 203. Still further, and as seen in the drawings, a multiplicity of semi-circular shaped engagement apertures 213 are formed in a given pattern in the axle receiving member 210, and are individually operable to be substantially coaxially aligned, at least in part, with the second passageway 166 which is formed in the individual pair of spaced support members 160. By individually aligning the respective engagement apertures 213, with the second passageway 166, an engagement or locking member 214 may be received in the coaxially aligned passageways thereby fixing the bracket body 170 in a given, predetermined rotational orientation relative to the bracket base 151. Similar to that described in the previous form of the invention, the engagement apertures 213 may take on a semi-circular form as seen in FIG. 11 or be circular as seen in FIG. 13. Still further, flat or otherwise linear portions 215 of the posterior facing edge 211 may be provided (FIGS. 12 and 12A). As was previously discussed in the earlier form of the invention, the bracket body 170, as seen in FIG. 12, may be rotated such that the flat or linear portions 215 may be individually positioned in predetermined, substantially parallel relation relative to the bracket base 151. Thereafter, the engagement or locking member 214 may be positioned between the bracket base 151, and the flat or linear portions 215 of the posterior facing peripheral edge 211. When this is done, the bracket body 170 is fixed in one of a multitude of predetermined rotational orientations relative to the bracket base 151, thereby providing a clinician with numerous, different orientations for the bracket body to act upon the arch wire 184, in order to achieve the benefits of the present invention. As seen in FIG. 12A, the peripheral edge 211 in yet still another possible form of the invention is shown and which includes just a multiplicity of flat or linear portions which are employed to fix the rotational orientation of bracket body 170 in the manner as discussed, above.

### Fourth Form of the Invention

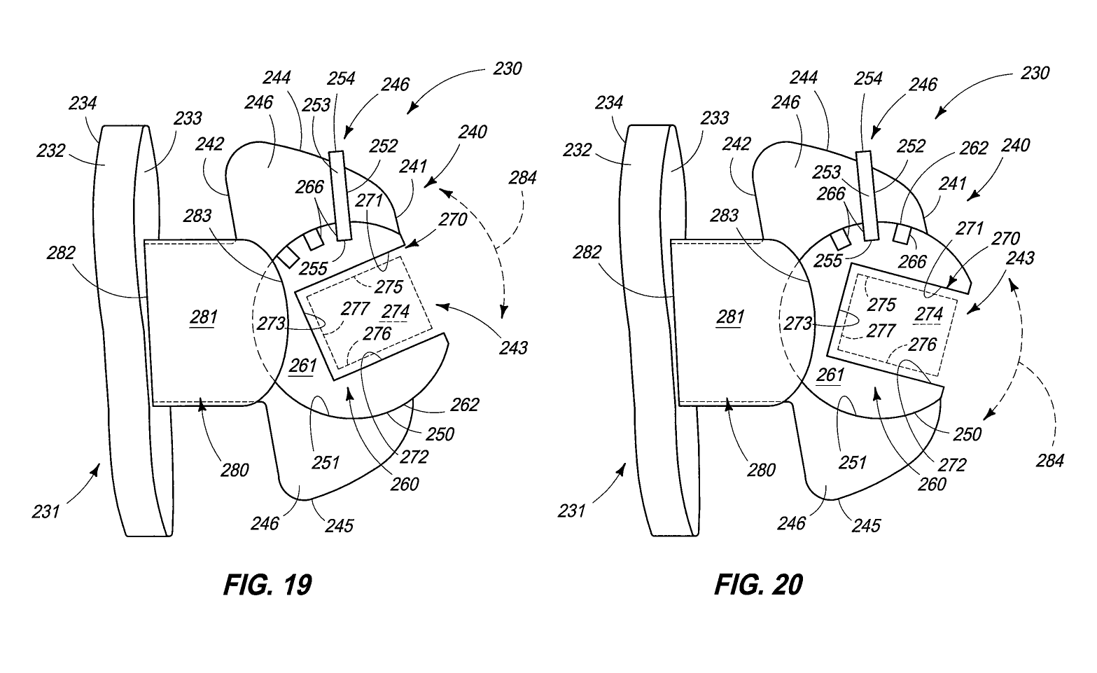

The fourth form of the invention is generally indicated by the numeral 230, and is seen in FIGS. 17-22, respectively. In this fourth form of the invention, the orthodontic bracket 230 includes a bracket base 231 which, as previously described in the earlier forms of the invention, is suitably adhesively affixed to the anterior facing surface 12 of the patient's tooth 11. In this fourth form of the invention, the bracket base 231 includes a main body 232 which has an anterior facing surface 233, and an opposite, posterior facing surface 234, and which is affixed to the patient's tooth 11. The fourth form of the invention 230 includes a bracket body 240 which is mounted on, or otherwise made integral with, the anterior facing surface 233 of the bracket base 231. The bracket body 240 includes an anterior facing surface 241, and an opposite, posterior facing surface 242 which is located in predetermined spaced relation relative to the anterior facing surface 233 of the bracket base 231. An aperture 243 is formed in the anterior facing surface 241 of the bracket body, and which couples with or leads to an internal cavity which will be described in greater detail, below. Still further, the bracket body has a superior or upwardly facing surface 244, and an inferior, or downwardly facing surface 245.

The fourth form of the invention 230, and more specifically the bracket body 240 thereof, defines a transversely disposed, substantially cylindrically shaped cavity which is indicated by the numeral 250. The transversely disposed cavity 250 communicates with the aperture 243 which is formed in the anterior facing surface 241 thereof. The transversely disposed cavity 250 is defined by a cylindrically shaped sidewall 251. Additionally, and as seen in FIG. 17, and following, a first passageway 252 is formed in the bracket body 240, and extends from the superior or upwardly facing surface 244, and communicates with, or couples to, the transversely disposed cavity 250. The first passageway 252 is sized so as to receive an elongated locking member 253 which is seen in FIGS. 18 and 18A, respectively. The locking member has a superior edge 254 which extends superiorly, outwardly relative to the superior facing surface 244, and an opposite inwardly, or inferior edge 255, which can be moved along the first passageway 252, and into frictional or mating receipt relative to a rotating arch wire insert as will be described in the paragraphs which follow. As seen in the drawings, an aperture 256 is formed near the superior edge 254, and which allows a clinician's tool (not shown) to be passed through same, so that a clinician may exert a suitable amount of physical force on the locking member so as to move it along the first passageway 252, and into, and out of forcible, locking engagement with the arch wire insert which will be described in greater detail, below.

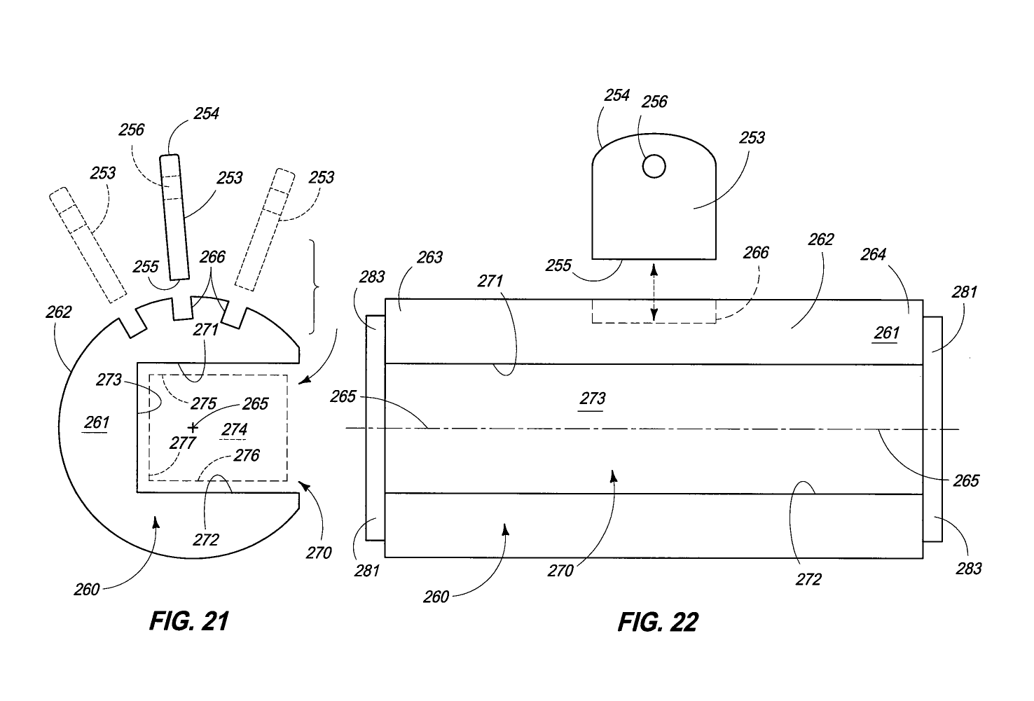

As seen in FIG. 17, and following, the bracket body 240, and more specifically, the transversely disposed cavity 250 is operable to receive, and matingly couple, and cooperate with, an arch wire insert which is generally indicated by the numeral 260. The arch wire insert 260 is sized so as to be substantially coaxially and matingly received within the transversely disposed, and substantially cylindrically shaped cavity 250. The arch wire insert has a main body 261, which has an exterior facing surface 262, and opposite, first and second ends 263 and 264, respectively (FIG. 22). As provided, the arch wire insert is generally rotatable about its longitudinal axis 265, as seen in FIG. 22. Still further, as seen in FIGS. 21 and 22, a plurality of spaced, radially outwardly located locking member channels 266 are formed in the exterior facing surface 262, and are sized so as to matingly receive the locking member 253, and more specifically the inferior or distal edge or end 255 thereof. The distal edge or end 255 may be moved into mating engagement with one of these several locking member channels 266 so as to selectively, fixedly position or orient the arch wire insert 260 in a given location relative to the bracket body 240 to achieve the benefits of the present invention.

The arch wire insert 260, as seen in FIG. 17, and following, has formed therein an arch wire slot 270, having a rectangular cross sectional design. The arch wire slot is defined by a top or superior facing surface 271, and an opposite, bottom or inferior facing surface 272. A posteriorly positioned rear wall 273 connects the top and bottom surfaces to provide a rectangularly shaped slot within which the arch wire, as will be described below, is received. The arch wire 274 is of a rectangular shape and a conventional design, and further has top and bottom surfaces 275 and 276, respectively, and opposite side walls 277. The arch wire 274 is retained within the arch wire slot 270 by a ligature of conventional design, and which is not shown, and which extends between the tie wings 246, and which lays, at least in part, within conformable contact with the anterior facing surface 241, of the bracket body 240. The ligature is not shown in FIGS. 17-20, so as to allow the features of the present invention to be seen more clearly. As illustrated in FIG. 17, and following, a portion of the arch wire insert 260 extends outwardly through the aperture 243 which is defined by the anterior facing surface 241 of the bracket body. This portion of the main body extending outwardly through the aperture 243, is frictionally engaged by the ligature, not shown.

The fourth form of the invention, as seen in FIGS. 17 and 22, respectively, includes a pair of end caps which are generally indicated by the numeral 280. The end caps have a main body 281, which has a posterior facing edge 282, and which is affixed, or otherwise made integral with, the anterior facing surface 233, of the bracket base 231. Further, the main body has an anterior facing, and curved edge 283, and which is positioned anteriorly, outwardly, relative to the bracket base 231, and which further overlaps, and at least partially occludes, the transversely disposed cavity 250. As will be understood, once the arch wire insert 260 is received within the transversely disposed cavity 250, the fixing or mounting of the end caps 280 over a portion of the transversely disposed cavity 250 is effective in securing or otherwise maintaining the arch wire insert 260 in rotatable receipt within the bracket body 240. As further illustrated by studying FIGS. 17-20, respectively, the arch wire insert 260 is selectively rotatably moveable along a path of travel which is generally indicated by the numeral 284. By the selective rotation of the arch wire insert 260, and then by the use of the locking member 253 which engages the individual locking member channels 266, a clinician can properly rotate the arch wire insert about the longitudinal axis 265, and thereby place it in an appropriate fixed angle or orientation so as to receive the arch wire 274 therein. Once received therein, the mating cooperation of the arch wire slot 270, in combination with the arch wire 274, provides a clinician the ability to implement first, second and third order movements of a patient's tooth 11 upon which the fourth form of the invention 230 is mounted.

### Fifth Form of the Invention

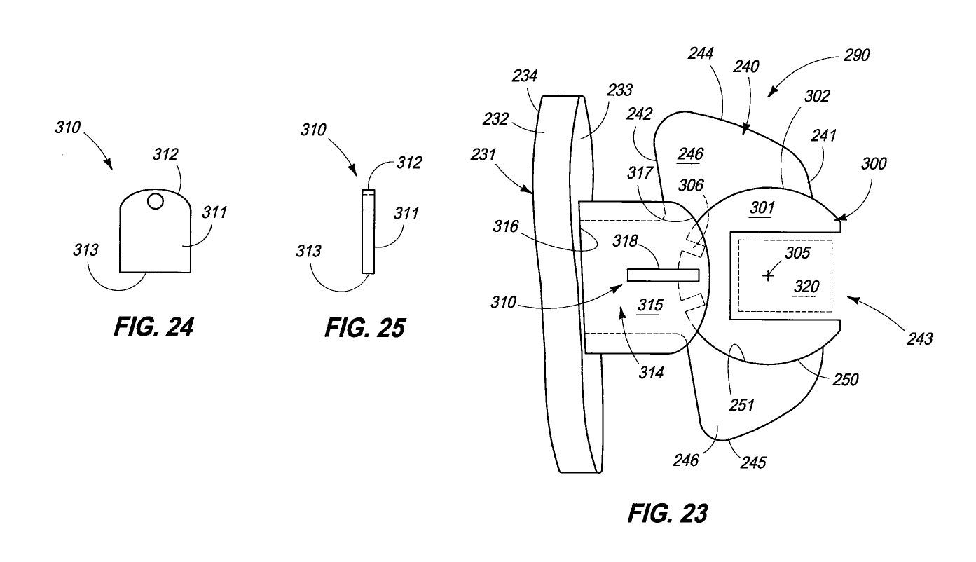

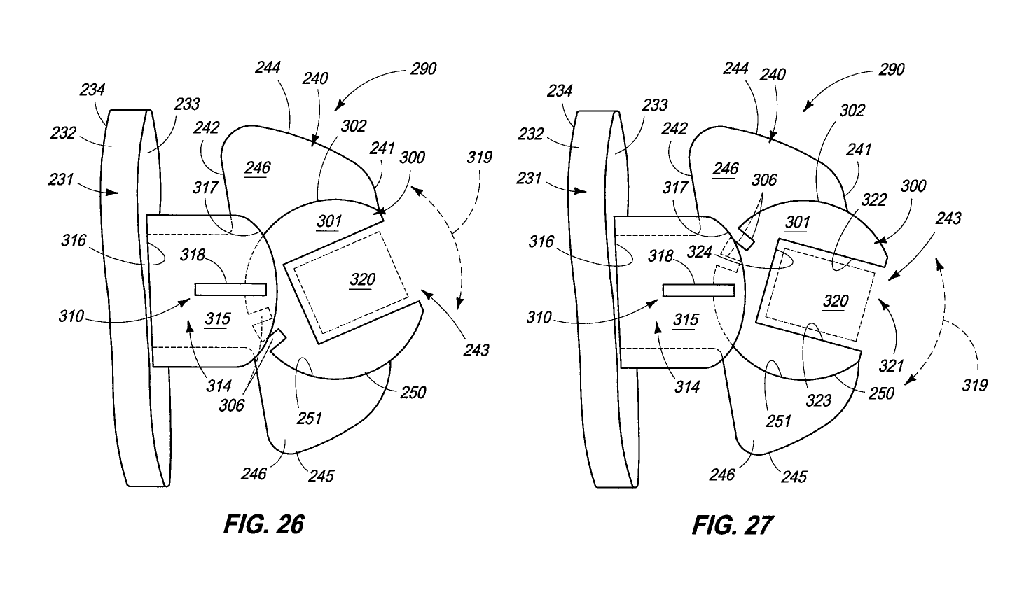

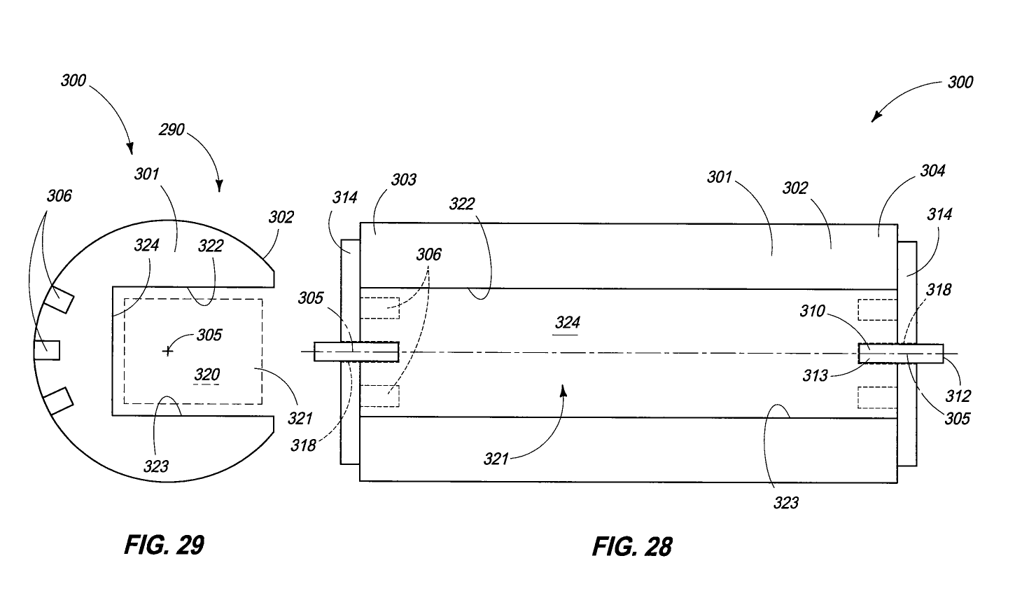

The fifth form of the invention is generally indicated by the numeral 290, and is illustrated in FIGS. 23-28, respectively. In this disclosed form of the invention, common structures bear similar numerals from that relating to the fourth form of the invention. Therefore, for purposes of brevity, the discussion relative to the bracket base 231, and bracket body 240, remain substantially identical to that previously discussed, relative to the fourth form of the invention 230. In the fifth form of the invention 290, the bracket body 240 receives, and otherwise rotatably supports, an arch wire insert which is generally indicated by the numeral 300 (FIGS. 28 and 29). The arch wire insert 300 is substantially cylindrically shaped, and is operable to be matingly, and coaxially received within the transversely disposed, and subsequently cylindrically shaped cavity 250 as defined by the bracket body 240. Again, the arch wire insert 300 has a main body 301 which has an exterior facing surface 302, and which further has opposite first and second ends 303 and 304, respectively. The arch wire insert 300, similar to the earlier arch wire inserts, which have been previously disclosed for the various forms of the invention, has a longitudinal axis 305. The main body 301 is operable to rotate, at least in part, about the longitudinal axis 305, so as to orient an arch wire slot, which will be described, below, in an appropriate orientation so as to achieve the benefits of the present invention. As seen in the drawings, a multiplicity of locking member channels 306 are formed in the opposite first and second ends 303 and 304, respectively, and which are operable to matingly cooperate with a locking member which will be discussed in the paragraphs which follow.

With regards to the fifth form of the invention 290, the fifth form of the invention includes a locking member which is generally indicated by the numeral 310, as seen in FIGS. 24 and 25, respectively. The locking member has a main body 311 which has a superior, or upwardly facing edge 312, and a lower, or inferior facing edge 313. Again, with respect to the fifth form of the invention, and similar to that seen in the fourth form of the invention 230, individual end caps 314 are affixed to, or otherwise made integral with the anterior facing surface 241 of the bracket body 240, and extend anteriorly, outwardly relative thereto. The respective end caps 314 have a main body 315, and the posterior edge 316 is either, on the one hand, matingly affixed, or otherwise made integral with the interior facing surface of the bracket body. Further, the respective end caps have an anterior facing edge 317 which in this form of the invention is shown in a curved configuration. Further, a narrowly rectangular passageway 318 is formed through the main body 315, and is operable to receive the locking member 310 therein. The respective locking members 310 are individually operable to extend through the passageway 318, and be received within the individual locking member channels 306 which are formed in the opposite first and second ends 303 and 304 respectively of the arch wire insert 300 as illustrated. In this manner, it should be understood, a clinician may move the individual locking members 310 out of engagement with the arch wire insert 300, and thereafter rotate the arch wire insert along the path of travel 319 to position it so as to receive an arch wire as will be described, below. Once the arch wire is received within the arch wire insert 300, a ligature, not shown, secures the arch wire within the arch wire insert. The mating cooperation of the arch wire, as will be described below, within the arch wire slot, is effective in providing first, second and third order movements to a patient's tooth 11 so as to achieve the benefits of the present invention. As noted in the drawings, a rectangular shaped arch wire 320 of conventional design is received within an arch wire slot 321 which is formed in the main body 301 of the arch wire insert 300 as earlier discussed with the other forms of the invention. Again, the arch wire slot has a top surface 322, a bottom surface 323, and a sidewall 324. Again, as was discussed with the fourth form of the invention 230, a ligature, not shown, is received about the tie wings 246, and is operable to maintain the arch wire 320 within the arch wire slot 321. Again, the mating cooperation of the arch wire 320, with the rectangular shaped arch wire slot 321, and depending upon its fixed, rotational orientation, facilitates the provision of first, second and third order movements to the patient's tooth 11.

### Sixth Form of the Invention

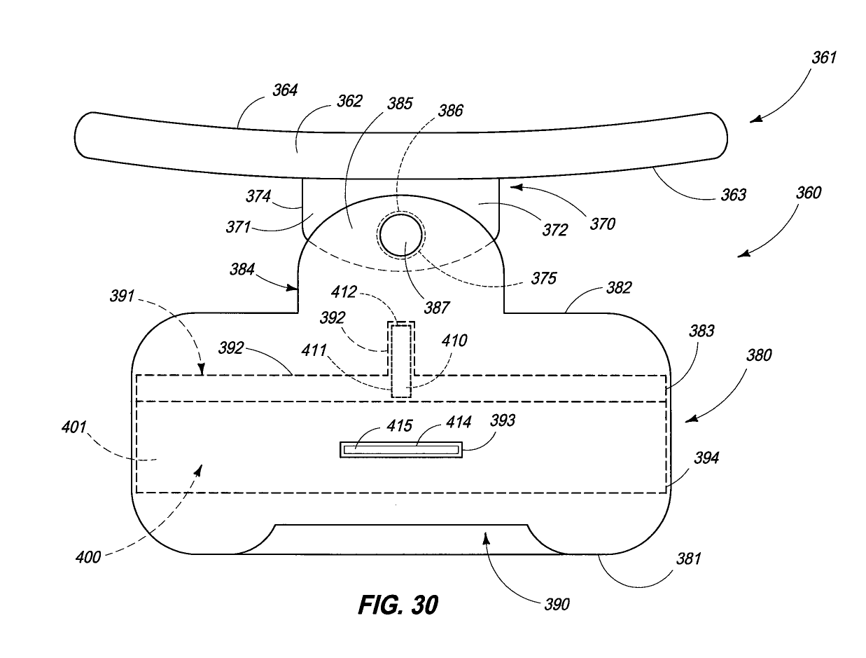

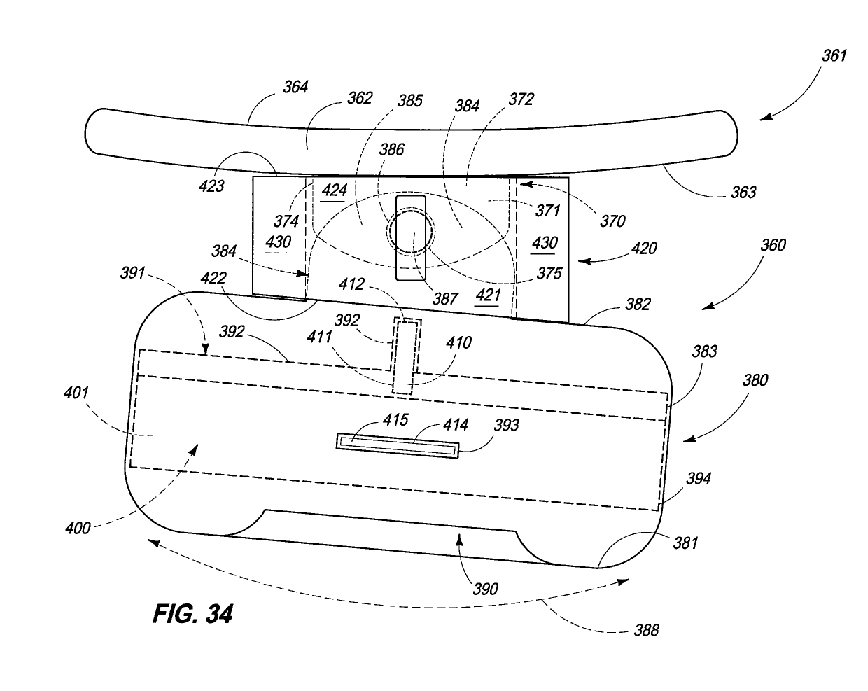

The sixth form of the invention is generally indicated by the numeral 360, and is best seen in FIGS. 30-35, respectively. The sixth form of the invention 360 like the several earlier forms of the invention described in this application, includes a bracket base 361 which is operable to be releasably, adhesively affixed to the anterior facing surface 12 of a patient's tooth 11 (FIG. 1) to affect the numerous benefits of the present invention. In particular, the bracket base 361 has a main body 362 having an outwardly or anterior facing surface 363, and an opposite, posterior facing surface 364. Additionally, and as seen in FIG. 30, the present invention 360 includes a bracket support or axle engagement member which is generally indicated by the numeral 370, and which is mounted on, or otherwise made integral with the anterior facing surface 363, of the bracket base. The bracket support or axle engagement member 370 extends anteriorly outwardly relative to the bracket base 360. The bracket support member, and more specifically the main body thereof 371, has a superior or upwardly facing surface 372, and an opposite, downwardly, or inferior facing surface which is not shown, but which is substantially parallel to the superior facing surface. Additionally, the main body 371 includes opposite, and substantially parallel sidewalls 374. As seen in the drawings, a passageway 375 is formed in the main body 371, and which extends from the superior or upwardly facing surface 372, to the lower or inferior facing surface to provide a passageway to receive an axle as will be described in greater detail, hereinafter.

The bracket base 361 rotatably mounts a bracket body 380 which is moveable along a given, arcuately shaped, and horizontally disposed path of travel as will be described, below. The bracket body 380 includes an anterior facing surface 381, and an opposite, posterior facing surface 382 which is disposed in predetermined, spaced relation relative to the anterior facing surface 363 of the bracket base 361. The bracket body 380 includes a superior facing surface 383, as seen in FIG. 30, and following. Extending posteriorly, rearwardly, relative to the posterior facing surface 382 is a pair of bracket body support members 384 which are disposed in predetermined, substantially parallel, spaced relationship. The pair of spaced bracket body support members are operable to be received or positioned on the opposite sides of the bracket support or axle engagement member 370. Further, the respective bracket body support members 384 have a superior facing surface 385 which has an aperture 386 formed therein. The aperture 386 which is formed in the respective pair of bracket body support members 384, are substantially coaxially aligned. When the bracket body support members 384 are substantially coaxially aligned with the passageway 375, which is formed in the bracket support member 370, an axle 387, can be received through the coaxially aligned apertures 386, and passageway 375, so as to render the bracket body 380 horizontally rotatable relative to the bracket base 361. As seen in FIG. 30, and following, the bracket base 380 defines an aperture 390 which is formed in the anterior facing surface 381 of the bracket body 380. The bracket body 380 further defines a transversely disposed substantially cylindrically shaped cavity 391 similar to that which is described with respect to several previous forms of the invention. Additionally, an elongated, substantially vertically oriented engagement channel 392 is formed in the bracket body, and communicates with the transversely disposed cavity 391. Additionally, and as seen in the plan view of FIG. 30, and following, a locking member aperture 393 is formed in the superior facing surface 383, and further extends downwardly and communicates with the transversely disposed, substantially cylindrically shaped cavity. As seen in FIG. 30, and following, the superior facing surface 383 defines tie wings 394 which are similar to that described with the earlier forms of the invention.

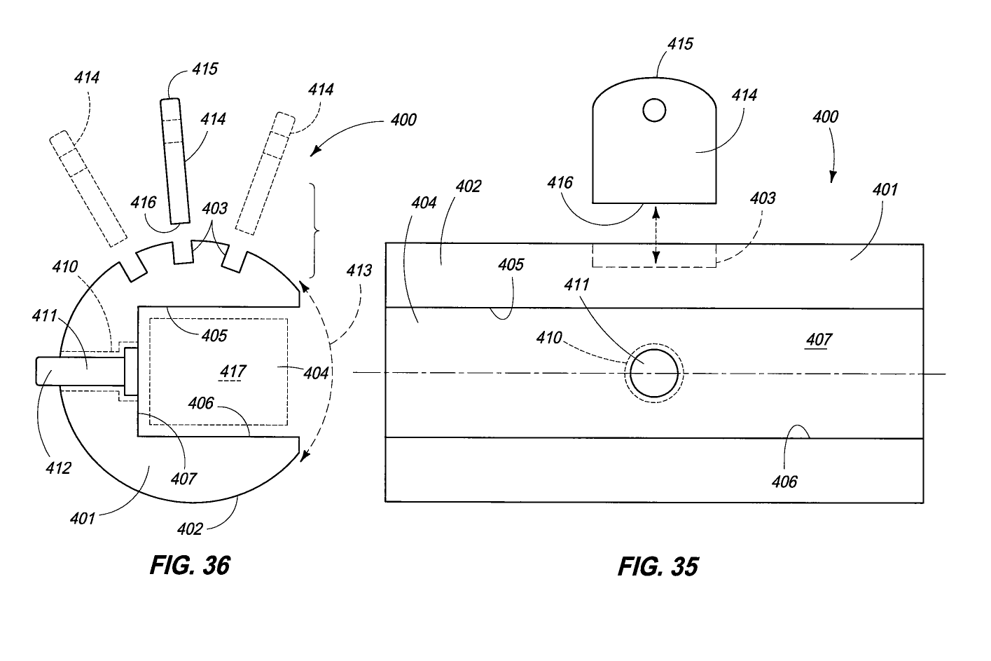

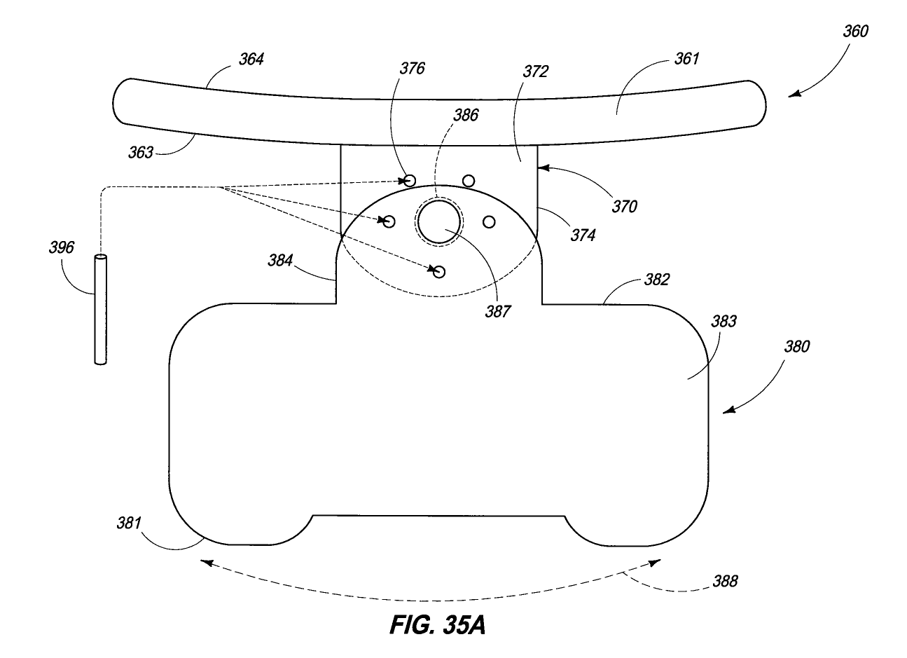

The sixth form of the invention 360 includes an arch wire insert 400 (FIGS. 35 and 36) and which is substantially elongated, and cylindrically shaped, and which is sized so as to be coaxially, and telescopingly received within the transversely disposed cavity 391. The arch wire insert 400 is similar to that described in the earlier forms of the invention, and includes a main body 401 which has an exterior facing surface 402. A multiplicity of spaced, elongated locking member channels 403 are formed in the exterior facing surface, and are operable to be matingly engaged by a locking member which will be discussed below. The main body 401 further defines a transversely disposed and rectangularly shaped arch wire slot 404. Again, the arch wire slot 404 is similar to that earlier described, and is defined by superior, and inferior facing surfaces 405 and 406, and a sidewall 407. The arch wire insert 400 is operable to partially rotate within the elongated engagement channel 392 in order to provide a clinician a means to facilitate first, second and third order movements of a patient's tooth 11. As seen in the drawings, a generally radially extending passageway 410 is formed in the main body 401 of the arch wire insert 400, and which is substantially aligned, and communicates with, the vertically disposed, and elongated engagement channel 392 which is formed in the bracket body 380. The present invention 360 includes an elongated engagement member or retaining pin 411 having a distal end 412. The engagement member or retaining pin 411 is received in the radially oriented passageway 410, and the distal and 412, is received within the elongated engagement channel 392. As was discussed in some of the previous forms of the invention, the engagement member or retaining pin 411 retains the arch wire insert 400 within the bracket body 380, and thereby defines a path of travel 413 as seen in FIG. 36. Additionally, the sixth form of the invention 360 includes a movable locking member 414. The locking member 414 is operably received, and cooperates with, the locking member aperture 393 which is formed in the bracket body 380. The locking member 414 has a superior edge 415 which may be engaged by a clinician's tool to move it within the locking member aperture, and further has an inferior or lower edge 416 which is operable to be received within, and matingly cooperate with the respective locking member channels 403 which are formed in the main body 401 of the arch wire insert 400. By engagement of the locking member 414 with the arch wire insert 400, a clinician can rotatably, fixedly adjust the orientation of the arch wire insert 400 relative to the bracket body 380 thereby achieving the first, second and third order movements desired. The arch wire slot 404 receives a rectangularly shaped arch wire 417 therein, as seen in FIG. 36.

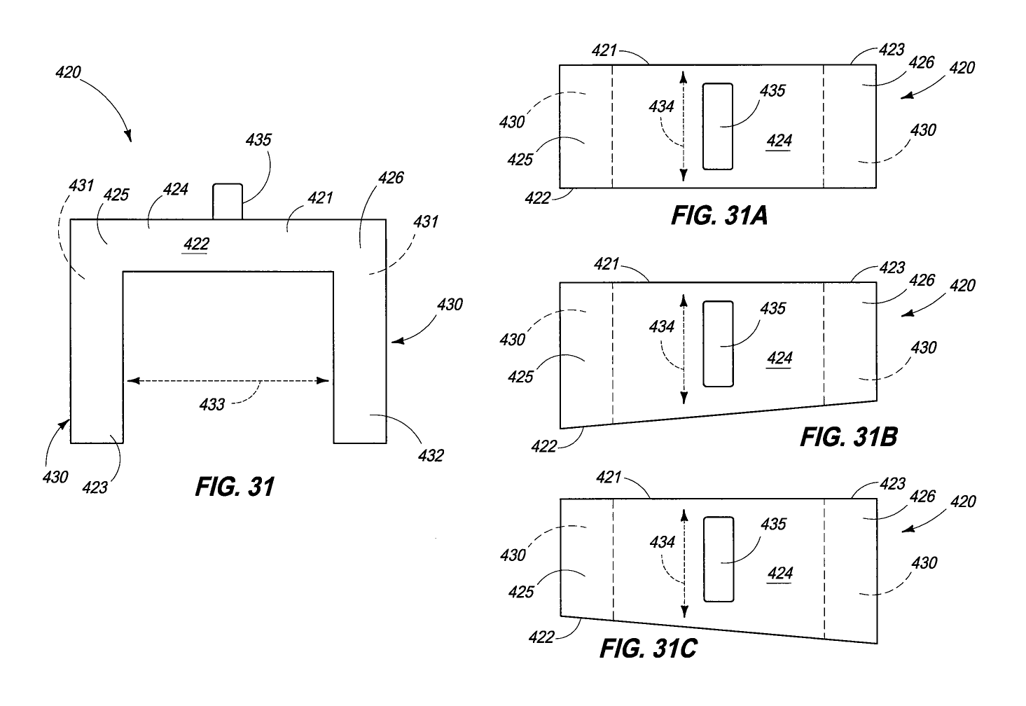

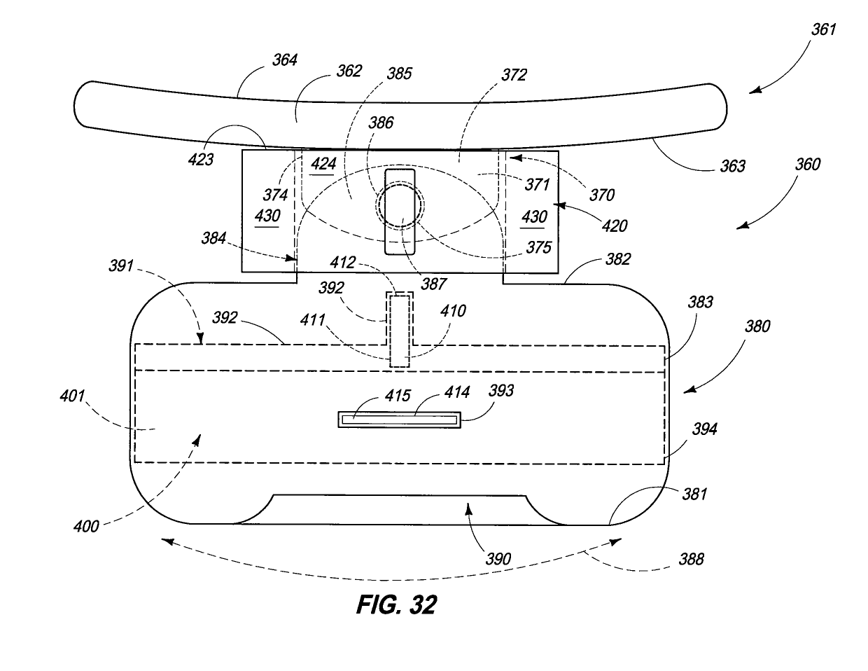

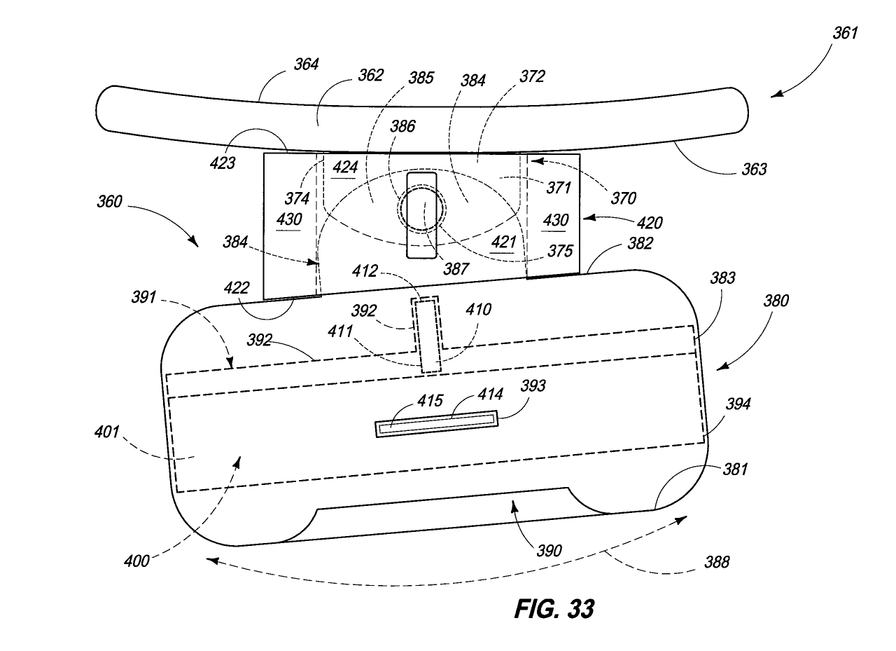

The sixth form of the invention 360 includes a rotation adjustment member which is generally indicated by the numeral 420, and which is seen in FIG. 31. In this regard, the rotation adjustment member has a main body 421 which has an anterior facing surface 422, and an opposite posterior facing surface 423. The rotation adjustment member 420 is defined, in part, by an elongated bridge member 424 which has opposite first and second ends 425 and 426, respectively. As seen in the drawings, the rotation adjustment member 420 includes a pair of depending legs 430 which extend downwardly from the first and second ends 425 and 426, respectively. The pair of depending legs have a first end 431, which is coupled to the bridge member 424, and an opposite distal end 432. A gap 433 is defined between the pair of depending legs, and which is sized so that the respective depending legs can be positioned on or straddle the opposite sides of the bracket support or axle engagement member 370 which is mounted on the bracket base 361. As will be seen in a FIGS. 31A, 31B and 31C, the bridge member 424, and the respective depending legs 430, may have individually different width dimensions which are generally indicated by the numeral 434. As seen in FIG. 31A, the width dimension of the bridge member, and the pair of depending legs 430, are substantially identical. However, in FIG. 31B, it will be noted that the depending legs, as illustrated, have different width dimensions, and the bridge member 424 has a variable width dimension. FIG. 31C shows a mirror image of FIG. 31B. As will be seen in FIGS. 32 and 33, the rotational adjustment member 420, when placed in the region or gap which is defined between the anterior facing surface 363 of the bracket base 361, and the posterior facing surface 382, of the bracket body 380, is operable to rotatably fix the bracket body 380 in a given rotational orientation so as to achieve the benefits of the present invention. As will be recognized from a study of FIG. 30, and following, the sixth form of the invention allows a clinician to positionally adjust the orthodontic bracket 10 in such a fashion that the bracket body 380 can be located in a predetermined horizontal orientation along the path of travel 388, and further the arch wire insert 400 may be rotated along a substantially vertical path of travel 413 (FIG. 36). This movement provides a means to place the arch wire 417 in a position where the mating cooperation of the arch wire 417, with the arch wire slot 404, is effective so that first, second and third order movements of a patient's tooth 11 can be achieved in a manner not possible, heretofore. The rotational adjustment member 420 includes a handle 435 which is mounted on the bridge member 424, and which provides a convenient means whereby a clinician may use a suitable tool, not shown, to remove the locking member 414 so as to facilitate the rotation of the arch wire insert 400 to a given, predetermined orientation, so as to receive the arch wire 417, therein. Again, in this form of the invention, the rectangular shaped arch wire 417 is retained within the arch wire slot 404 by means of a suitable ligature, not shown. The ligature is operable to be received and matingly cooperate with the tie wings 394 which are defined by the bracket body 380.

The sixth form of the invention has an alternative version, which is seen in FIG. 35A. As seen in FIG. 35A, which represents a top plan view of the sixth form of the invention 360, this version of the invention includes features similar to that earlier described, and therefore bears similar numbers on identical structures. In particular, it will be recognized in this version of the invention, that the orthodontic bracket 360 includes a bracket base 361, which has an anterior facing surface 363. Again, in this alternative version of the invention, a bracket support or axle engagement member 370 is mounted on the anterior facing surface 363 of the bracket base 361. Further as seen in FIG. 35A, it will be recognized that multiple locking member passageways 376 are formed in a given pattern in the bracket support or axle engagement member 370 and pass completely therethrough. In this alternative version of the invention, the bracket body 380 which is provided, is rotatably moveable relative to the bracket support member 370. The bracket body 380, again, has an anterior facing surface 381, and an opposite, posterior facing surface 382. In this alternative form of the invention, a pair of bracket body support members 384 are provided. An aperture 386 is formed in the respective pair of bracket body support members 384, and which are individually coaxially aligned with an aperture, not seen, and which is formed in the bracket support or axle engagement member 370. An axle 387 is received through these coaxial aligned apertures, thereby rendering the bracket body 380 moveable along a path of travel which is generally labeled by the numeral 388. As will be recognized by study of FIG. 35A, multiple locking member passageways 395 are formed in the pair of spaced bracket body support members 384. These respective locking member passageways 395 are operable to be individually, coaxially aligned relative to the multiple locking passageways 376 which are formed in the bracket support or axle engagement member 370. When they are so coaxially aligned, a locking member, here, generally indicated by the numeral 396, is received therethrough and thereby fixedly, rotatably orients the bracket body 380 in a given orientation relative to the bracket base 361 in order to achieve the benefits of the present invention.

### Seventh Form of the Invention

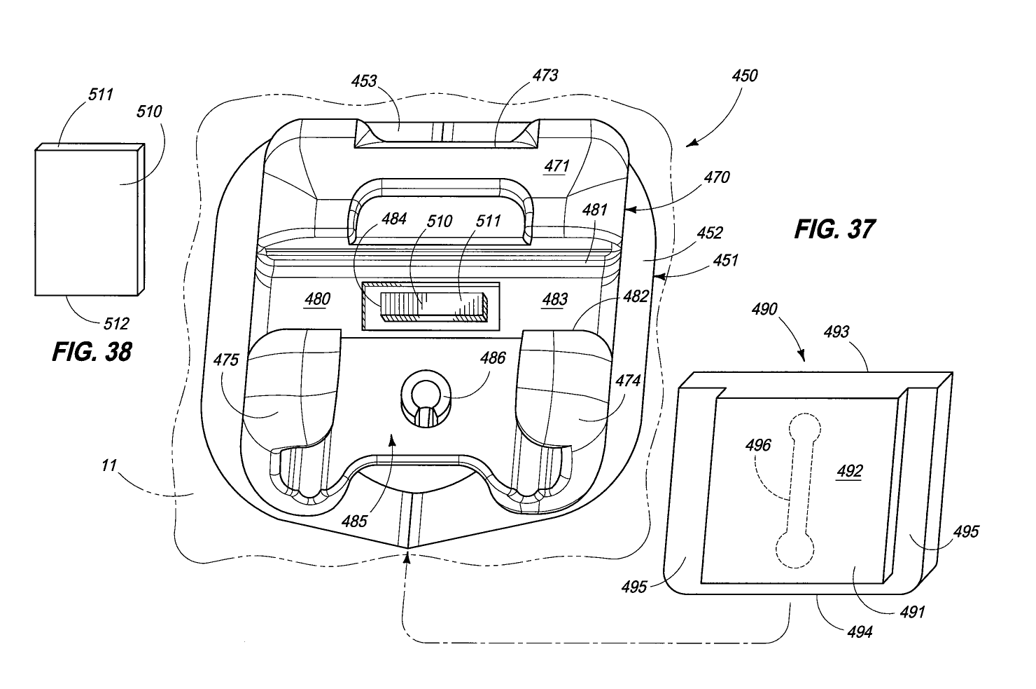

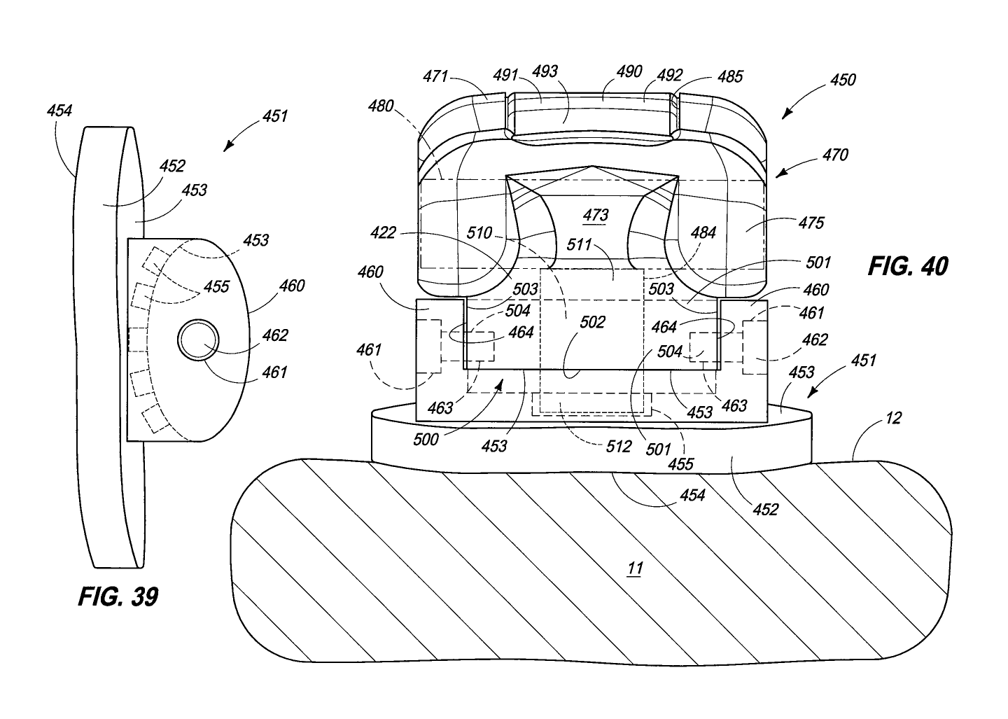

The seventh form of the invention is generally indicated by the numeral 450, and is seen in FIGS. 37-40, respectively. The seventh form of the invention 450 achieves the benefits of the present invention, as earlier described, and which includes allowing a clinician to achieve first, second and third order movements of a patient's tooth 11 once the orthodontic bracket 450 is appropriately mounted by an adhesive or the like, on the anterior facing surface 12 of the patient's tooth 11. FIG. 32 shows the seventh form of the invention 450 in a partially disassembled view for ease of understanding the structure, and the operation of the invention. In this regard, FIG. 37 shows an orthodontic bracket 450 which is useful for achieving passive ligation of a patient's tooth 11. As best seen in FIGS. 39 and 40, the seventh form of the invention 450 includes a bracket base 451 which is suitably affixed to a patient's tooth 11 by using adhesives, and other fastening techniques which are well known in the art. The bracket base 451 has a main body 452 which has an anterior facing surface 453, and an opposite, posterior facing surface 454 which is typically adhesively affixed to the anterior facing surface 12 of the patient's tooth 11. As best illustrated in FIGS. 39 and 40, the anterior facing surface 453 of the bracket base 451 has a concavely shaped surface which has formed therein a multiplicity of locking member channels 455, and which are further located in predetermined, substantially parallel, spaced relation along the anterior facing surface 453. Additionally, and as illustrated in FIGS. 39 and 40, respectively, a pair of spaced support members 460, are mounted on, or made integral with, the bracket base 451, and which extend posteriorly, outwardly relative thereto. Still further, and as illustrated in the drawings, a first passageway 461 is formed in each of the pair of support members 460. The respective first passageways 461 are substantially coaxially aligned. Still further, the respective first passageways 461 are sized so as to receive individual axle members 462, therein. The individual axle members have a distal end 463 which are able to rotatably cooperate with the bracket body as will be discussed in greater detail, hereinafter. As best illustrated in FIG. 40, a gap 464 is defined between the pair of spaced support members, and is operable to receive therein, a portion of the bracket body as will be discussed below. The bracket body, thereafter, rotates about the individual axle members in a manner similar to that which was previously described for the several earlier forms of the invention.

The seventh form of the invention 450 includes a rotatable bracket body which is generally indicated by the numeral 470. The bracket body 470 is defined by an anterior and a posterior facing surface 471 and 472, respectively. Still further, the bracket body 470 has both superior, and inferior facing surfaces 473 and 474, respectively. The anterior facing surface 471 defines opposed tie wings 475, which are similar to that which was disclosed with the other forms of the invention. The bracket body 470 has formed therein a transversely disposed arch wire slot 480 which is defined by opposed superior, and inferior facing surfaces 481 and 482, respectively, and which are disposed in predetermined, substantially parallel spaced relation. Still further, the rectangular arch wire slot includes a posteriorly positioned sidewall 483 which joins the superior and inferior facing surfaces together. Additionally, and as seen in FIG. 37, a locking member passageway 484 is formed in the posteriorly positioned sidewall 483 which defines, in part, the transversely disposed arch wire slot 480. Additionally, and formed in the anterior facing surface 471 of the bracket body is a generally vertically oriented gate channel 485 which is operable to matingly and slideably cooperate with a gate, as will be described in the paragraphs which follows. Located substantially centrally of the vertically oriented gate channel 485, is a spring member 486 which cooperates with the gate as will be described, to define a course of travel for the gate. Additionally, and formed in posterior sidewall 483, is a recessed region 487, and which surrounds the locking member passageway 484. This recessed region allows the locking member, which will be discussed, hereinafter, to be received in the passageway 484, but allows a sufficient amount of the locking member to be exposed so that it may be grasped by a clinician using a tool, such as tweezers, or the like, not shown.

As illustrated in the drawings, a moveable gate 490 is provided, and which is operable to cooperate with the bracket body 470, and which permits selective access to the arch wire slot 480, so as to place a rectangularly shaped arch wire, not shown, therein. The moveable gate, as illustrated, has a main body 491, which has an anterior facing surface 492, and superior and inferior facing edges 493 and 494, respectively. Additionally, a pair of vertically oriented, and recessed guidance channels 495 are formed in the opposite, vertically oriented peripheral edges, and which are sized so as to be received within the vertically oriented gate channel 485. This structure renders the gate 490 slideably movable relative to the bracket body 470. As illustrated in the drawings, and which is shown in hidden lines, a spring receiving channel 496 is formed in the posterior facing surface of the main body 491, and is operable to moveably cooperate with the spring 486 which is shown in FIG. 37. The spring receiving channel 496 provides, or defines a path of movement for the moveable gate 490 between a position whereby the moveable gate 490 is first positioned in a substantially non-occluding relationship relative to the transversely disposed arch wire slot 480, and a second position, where the gate is moved to an occluding or blocking position. In the occluding, blocking or closed position, the gate 490 captures or encloses the rectangular shaped arch wire within the arch wire slot 480. As seen in the plan view of FIG. 40, an axle receiving member 500 is made integral with, and extends generally posteriorly, rearwardly, relative to the posterior facing surface 472 of the bracket body 470. The axle receiving member has a main body 501, and further has a posteriorly oriented peripheral edge 502. Further, the main body is defined by a pair of substantially parallel sidewalls 503. The main body is sized so as to be received within the gap 464 which is defined between the pair of support members 460. As seen in FIG. 40, individual axle receiving passageways 504 are formed in each of the sidewalls 503, and are substantially coaxially aligned, and are sized so as to receive the distal end 463 of the respective individual axle members 462. Additionally, and as will be seen in FIG. 40, the locking member passageway 505 extends through the main body 501, and is coupled with the locking member passageway 484, and which is formed in the bracket body 470. Further, and as illustrated in FIG. 40, a locking member 510 is provided, and which is sized so as to be received within the respective locking member passageways 484 and 505, respectively. The locking member 510 has a first end 511, and a distal, second end 512 which is individually received within the respective locking member channels 455 which are formed in the anterior facing surface 453 of the bracket base 451. By selectively positioning the locking member 510 in the individual locking member channels 455, a clinician can rotatably, adjustably, and fixedly position the bracket body 470 in various angular orientations relative to the bracket base 451. Thereafter, and upon receiving an arch wire within the arch wire slot 480, and after further closing the moveable gate 490, the clinician may facilitate first, second and third order movements of a patient's tooth 11, in a clinically desirable manner.

### Eighth Form of the Invention

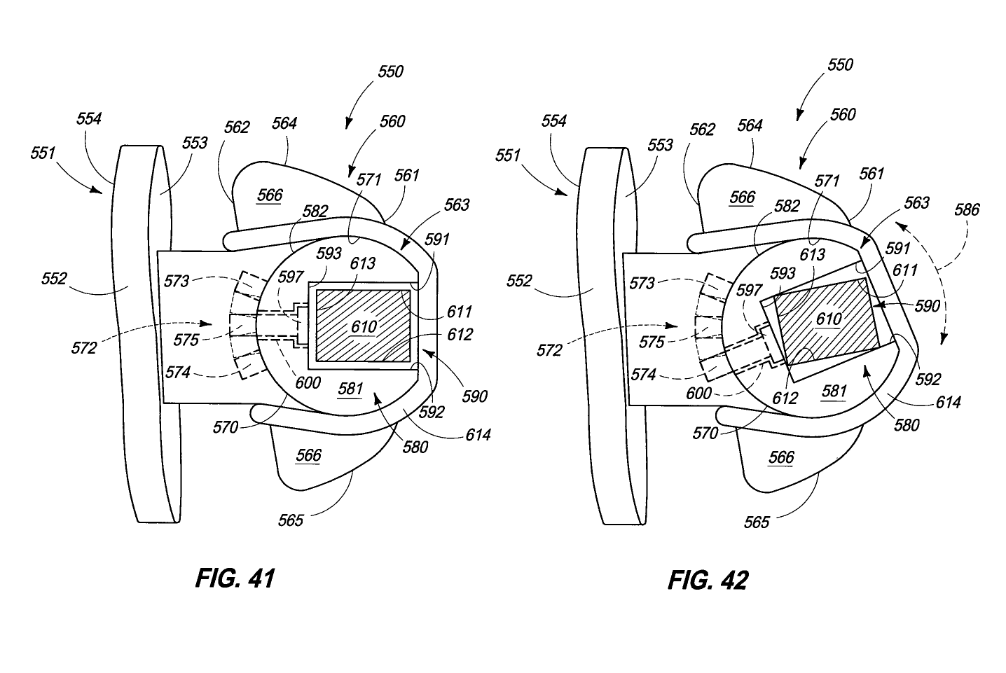

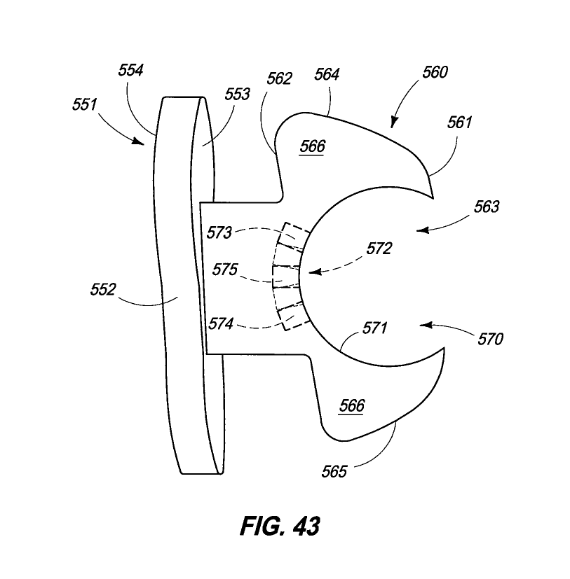

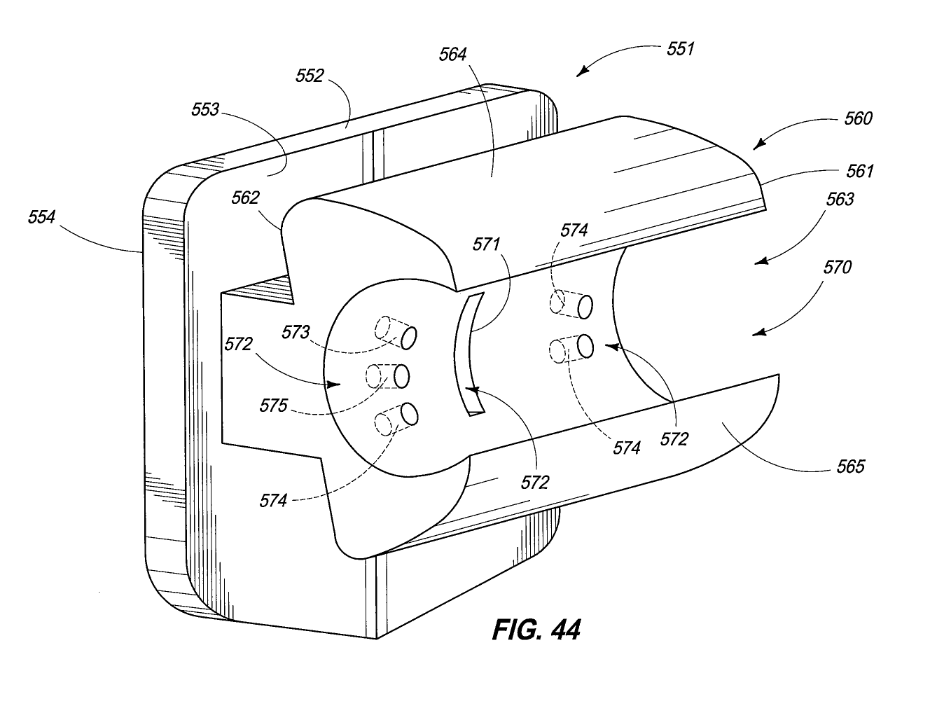

The eighth form of the invention is generally indicated by the numeral 550, and is best understood by a study of FIGS. 41 through 45, respectively. In this form of the invention, which is similar in some respects to the fourth form of the invention 230, the eighth form of the invention 550 includes a bracket base 551, which has a main body 552, and which further has an outwardly or anterior facing surface 553, and a posterior or rearwardly facing surface 554. The posterior facing surface, which is similar to the other forms of the invention as disclosed, is typically adhesively affixed to the posterior facing surface of the tooth of a patient which is undergoing treatment. Moveably affixed to the bracket base 551, is a bracket body, which is generally indicated by the numeral 560. The bracket body is defined, at least in part, by an anterior facing surface 561, and a posterior facing surface 562, which is positioned in spaced relation relative to the anterior facing surface 553, of the main body. Again in this form of the invention, an aperture 563 is formed in the anterior facing surface 561, and leads to a transversely disposed, substantially cylindrically shaped cavity, as will be discussed, below. Additionally, the bracket body 560 has a superior facing surface 564, and an inferior facing surface 565. Again, the superior and inferior facing surfaces each respectively define tie wings 566, which can be engaged by a ligature 614 of conventional design. The bracket body 560 defines a transversely disposed, and substantially cylindrically shaped cavity 570. The transversely disposed cavity 570 has a cylindrically shaped sidewall 571. As best seen by reference to FIG. 44, a multiplicity of locking member channels 572 are formed in the cylindrically shaped sidewall, and extend generally posteriorly inwardly, and rearwardly relative thereto. As best seen by reference to FIG. 44, the multiplicity of locking member channels are formed into a first group of locking member channels 573, which include an upper, lower and centrally disposed locking member channel; and a second group of locking member channels 574, which include just an upper and a lower locking member channel. As will be understood from studying the drawings, and the text which will follow, the respective locking member channels provide a convenient means for rotatably, adjustably positioning an arch wire insert in a given fixed rotational orientation relative to the bracket body 560, to achieve the benefits of the present invention.

It will be seen from a study of FIG. 44 that a substantially vertically oriented engagement channel 575 is formed in the cylindrically shaped sidewall 571 of the transversely disposed cavity 570. The engagement channel 575 has a first end 576, and a second end 577. Again this engagement channel defines a path of movement, as will be discussed, hereinafter, for the arch wire insert to move relative to the bracket body 560.

The transversely disposed, and substantially cylindrically shaped cavity 570 which is formed in the bracket body 560, receives an arch wire insert, which is generally indicated by the numeral 580. The arch wire insert 580 is formed of a cylindrically shaped main body, which is telescopingly received within the transversely disposed cavity 570. The main body 581 has an exterior facing surface 582, and is further defined by first and second ends 583 and 584, respectively. Still further, the arch wire insert has a longitudinal axis 585, about which the main body 581 rotates, at least in part. Additionally, it will be seen from a study of FIG. 42, that the main body 581 is operable to move along a path of travel, which is generally indicated by the numeral 586. This path of travel and movement is defined, in part, by an engagement member, which will be discussed in further detail, hereinafter.

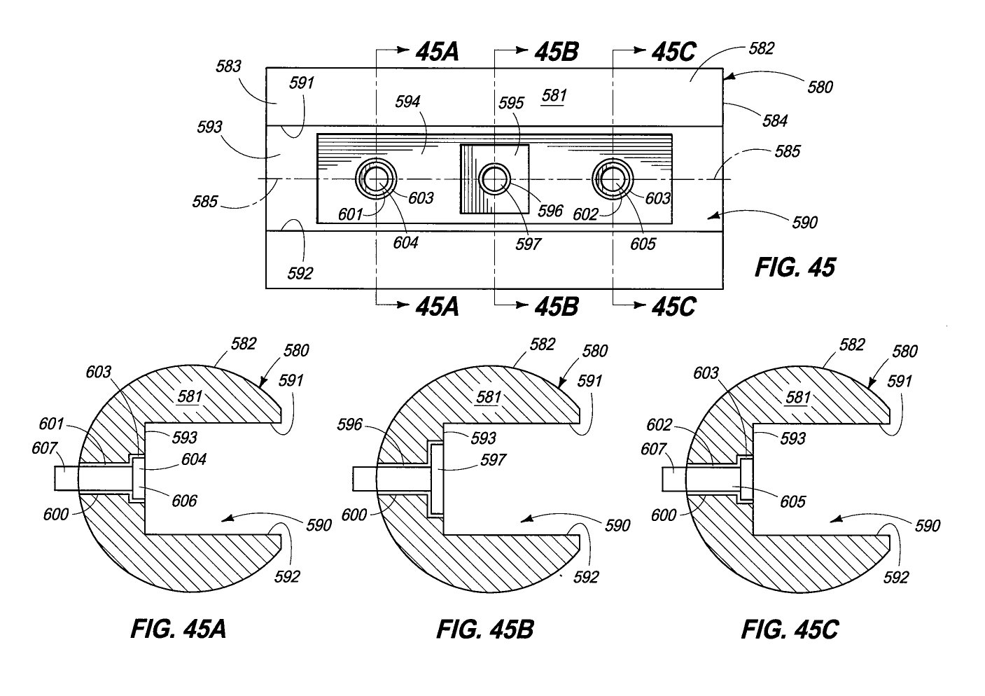

The main body 581 defines a rectangularly shaped arch wire slot 590, which extends between the first and second ends 582 and 583, respectively. The arch wire slot is placed in communication with the aperture 563, which is formed in the bracket body 560. The rectangularly shaped arch wire slot is defined by a top, or superior facing surface 591, and which is disposed in predetermined, substantially parallel, spaced relation relative to a bottom or inferior facing surface 592. Further, a rear wall 593 connects the superior, and inferior facing surfaces together, so as to form the substantially rectangularly shaped arch wire slot. As seen in FIG. 45, a primary, rectangular shaped recessed region 594 is formed in the rear wall 593. Additionally, a secondary, substantially square-shaped recessed region 595 is formed generally centrally of the primary region 594 (FIG. 45). Formed substantially centrally of the secondary, square-shaped recessed region 595 is a passageway 596, which extends substantially radially, outwardly through the main body 581, and which is substantially coaxial aligned with the engagement channel 575, which is formed in the bracket body 560. Additionally, and as seen in FIG. 45 and following, a multiplicity of locking member passageways 600 are generally formed in the arch wire insert 580. The locking member passageways include a first group of locking member passageways 601, and a second group of locking member passageways 602. The respective locking member passageways are located on the opposite sides of the passageway 596, which is formed in the main body 581 of the arch wire insert. Additionally, and as will be seen in FIG. 45, a recessed region 603 is formed about the respective locking member passageways 601 and 602, respectively. As seen in the drawings, first and second locking members 604 and 605, respectively, are received within the first and second locking member passageways 601 and 602, respectively. The recessed region 603 provides a convenient means whereby the proximal end of the respective locking members can be recessed below the surface of the rear wall 593, and provides adequate space for an orthodontist to use a tool, such as tweezers, to grasp the respective first and second locking member 604 and 605, respectively, so as to remove them from their respective passageways. The respective first and second locking members 604 and 605, each have a distal end 607, which is operable to be matingly received within individual locking member channels 572, which may be located within either the first or second group 573 or 574, respectively. By the placement of the distal end within the individual locking member channels, a clinician can readily, fixedly position the arch wire insert 580 in various, fixed, angular orientations relative to the bracket body, such as is seen in FIG. 42, in order to implement the features of the present invention. Again, by grasping the proximal end 606 of the first and/or second locking member, they may be individually placed so as to provide a wide range of fixed orientations for the arch wire insert to achieve the benefits of the present invention.

Received within the arch wire slot 590, is a rectangularly shaped arch wire 610 of conventional design. The arch wire 610 has top and bottom surfaces 611 and 612, respectively. Further, the arch wire has sidewalls 613, which connect the top and bottom surfaces together. A ligature 614 is provided and which secures the arch wire 610 within the archwire slot 590. The arch wire 610 is acted upon by the arch wire slot to achieve the benefits of the present invention. Additionally, and as will be seen, the passageway 596, which receives the engagement member 597, defines the course of travel along which the arch wire insert may travel.

### Ninth Form of the Invention

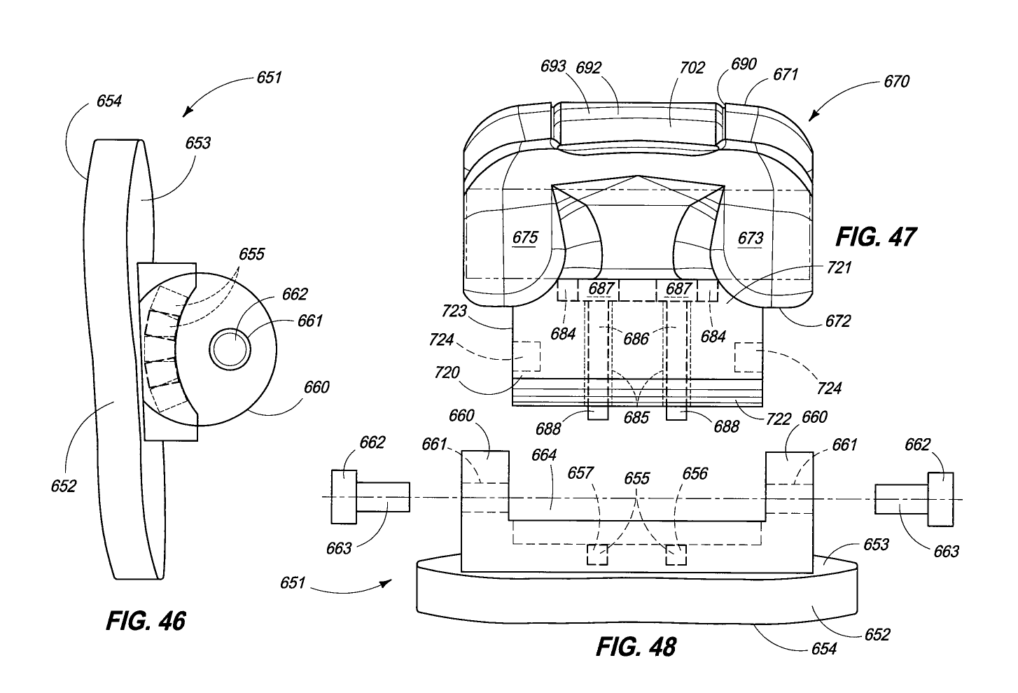

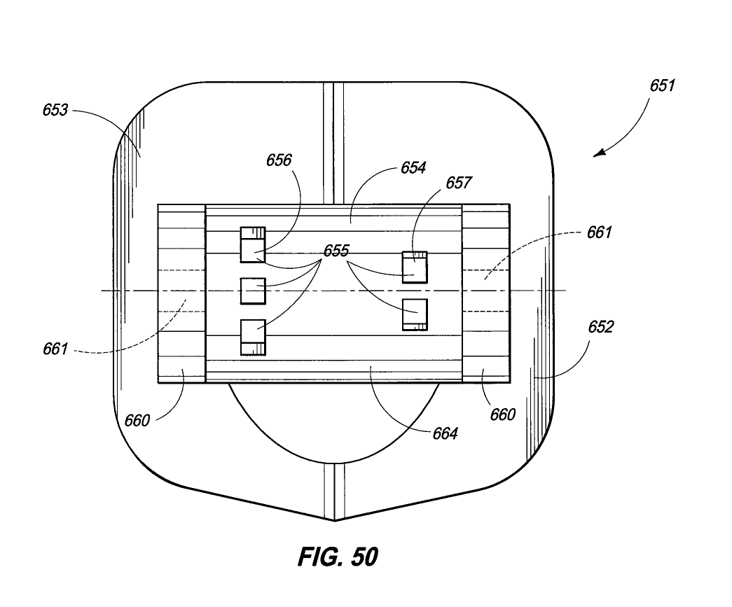

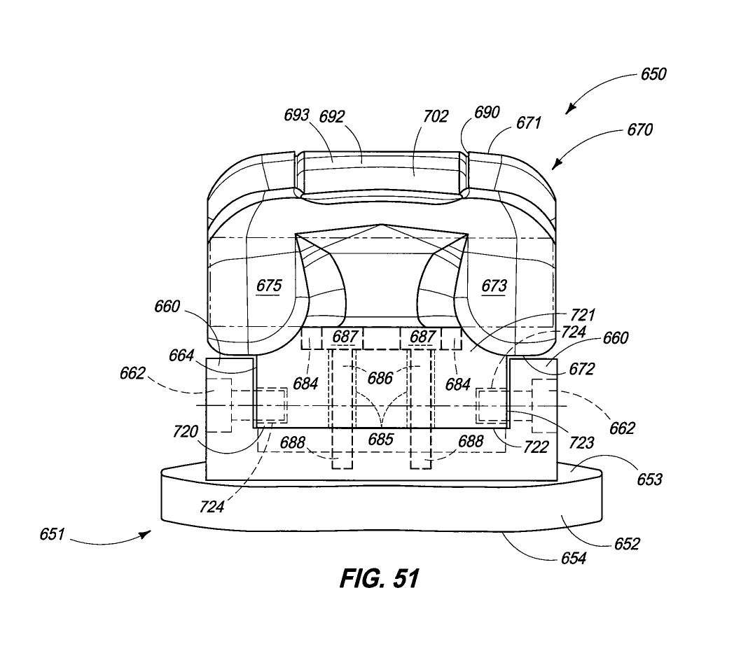

The ninth form of the invention is generally indicated by the numeral 650, and is best seen in FIGS. 46 through 54, respectively. In this form of the invention, the orthodontic bracket 650 includes a bracket base which is generally indicated by the numeral 651, and which has a main body 652. The main body 652 has an anterior facing surface 653, and an opposite, posterior facing surface 654, which is typically adhesively affixed to the anterior facing surface of a patient's tooth which is being treated. As seen in FIGS. 46, 48 and 50, respectively, a multiplicity of locking member channels 655 are formed in a given pattern within the anterior facing surface 653 of the bracket base 651. In this regard, the plurality of locking member channels are formed into a first group 656, which includes three equally spaced locking member channels; and a second group 657, which is spaced, therefrom, and which includes at least two locking member channels. It will be seen by studying FIG. 50 that the locking member channels provide a means for nearly substantially continuous rotational adjustment of the position of the bracket body, as will be discussed in greater detail, hereinafter, and which is similar to that seen in the eighth form of the invention, and which was previously disclosed. As illustrated in FIG. 46 and FIG. 50, respectively, a pair of spaced support members 660 are mounted on the anterior facing surface 653, and extend typically, normally, outwardly therefrom. The pair of spaced support members 660 are disposed in predetermined, spaced relationship. Formed in each of the pair of spaced support is an axle passageway 661, which is substantially coaxially aligned with the other one formed in the adjacent support member. The respective axle passageways are operable to matingly receive an axle 662, therethrough, and which provides a means for rotatably supporting the bracket body, which will be discussed in greater detail, hereafter. Each of the respective axle members 662, have a distal end which is positioned in the gap or space that is defined between the pair of spaced support members 660. Additionally, it will be recognized from the view, as seen in FIG. 48, that a gap 664, having predetermined width and depth dimensions, is defined between the pair of support members 660.

The ninth form of the invention 650 includes a rotatable bracket body which is generally indicated by the numeral 670, and which is similar to the seventh form of the invention 450. The bracket body 670 has an anterior facing surface 671, and an opposite, posterior facing surface 672. Still further the bracket body 670 has a superior facing surface 673, and an opposite, inferior facing surface 674. The bracket body 670 defines traditional tie wings, which again, are indicated by the numerals 675.

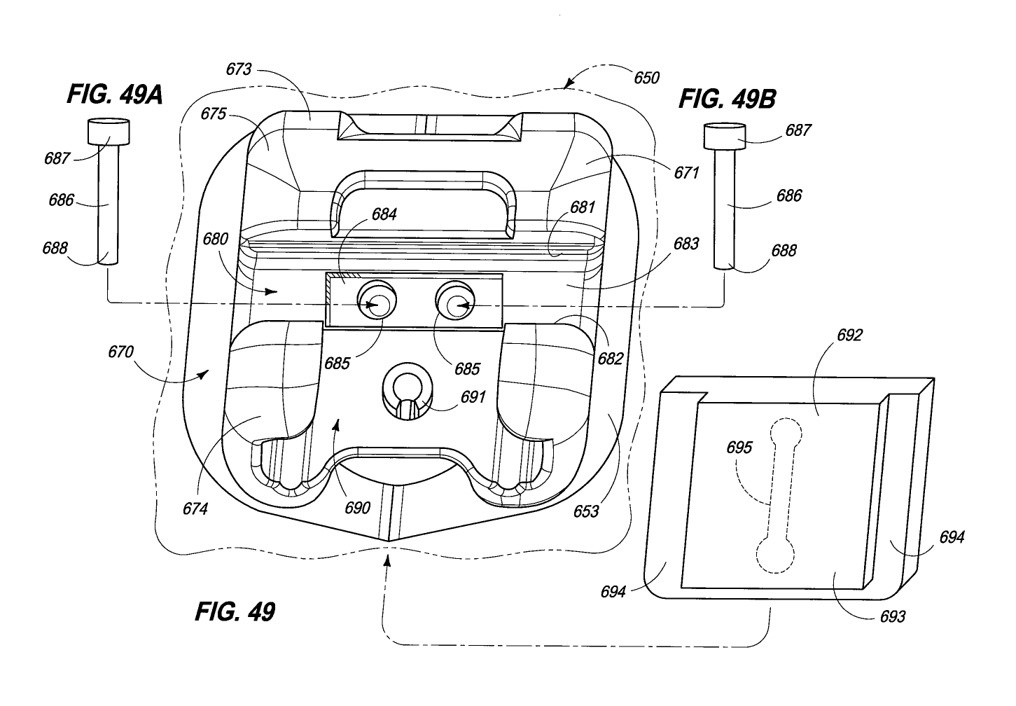

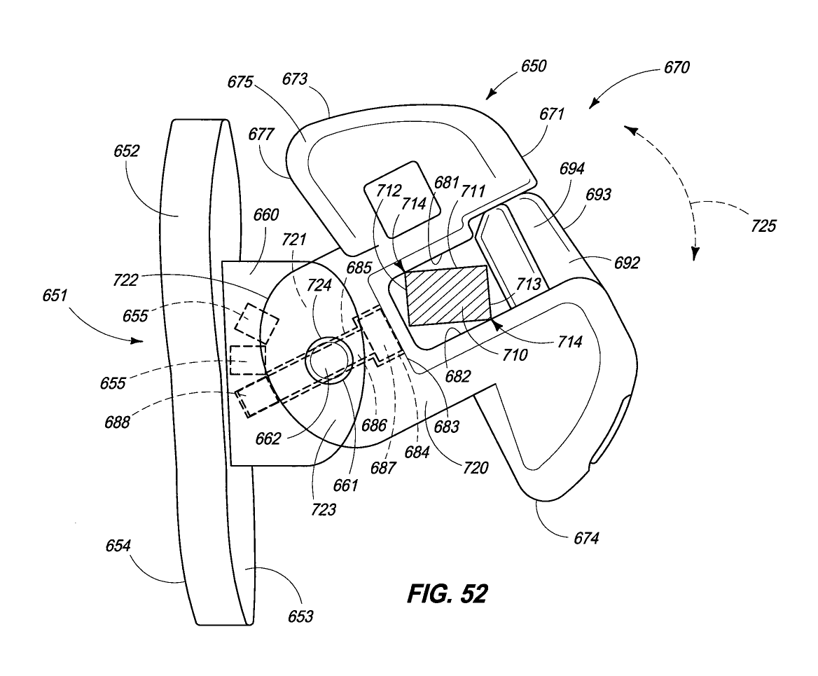

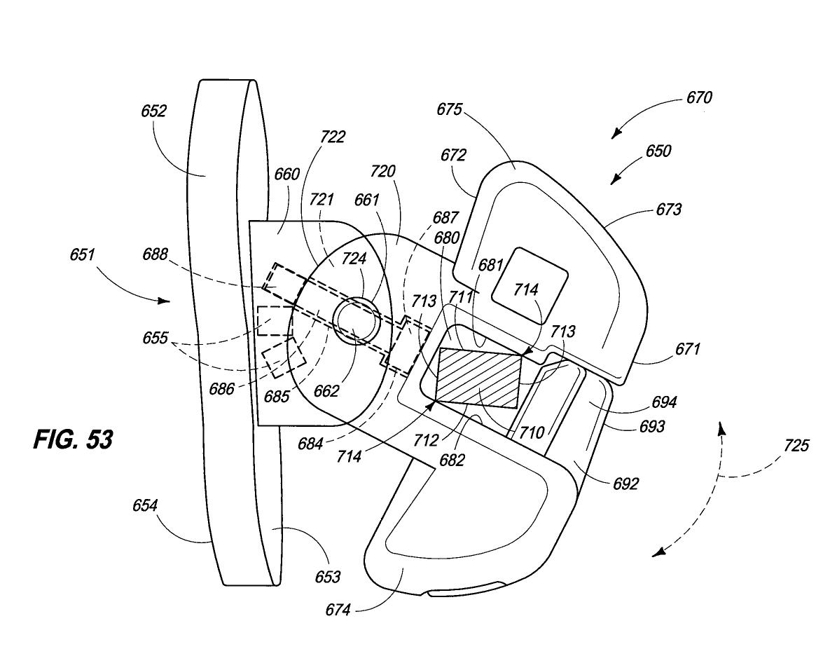

The bracket body 670 further defines a transversely disposed, and rectangularly shaped arch wire slot 680 which is positioned between the superior and inferior facing surfaces 673, and 674, respectively. The transversely disposed arch wire slot is defined by a top, or superior surface 681, and a bottom, or inferior facing surface 682 which are disposed in predetermined substantially parallel spaced relation, one relative to the other. Still further, the transversely disposed arch wire slot 680 is defined, in part, by a posteriorly located sidewall 683 which joins the superior and inferior facing surfaces 681 and 682, together. Additionally, and as best seen by reference to FIG. 49, a substantially narrowly rectangular recessed region 684, is formed in the posteriorly located sidewall 683. The recessed region has formed therein a pair of locking member passageway 685 which extend posteriorly, rearwardly, relative to the bracket body 670, and are operable to receive individual locking members 686 therein. The respective locking members 686 are substantially identical, and have a first or proximal end 687, and a second or distal end 688. The distal end 688 is operable to be received within or cooperate with the respective first and second groups 656 and 657 of the plurality of locking member channels 655. As earlier discussed, the locking member channels 655 are formed in the anterior facing surface 653 of the bracket base 651. By receipt of the individual locking members in the respective locking member channels 655, the rotatable bracket body, as will be discussed in further detail, below, is operable to rotate in a given vertical plane and then be fixedly located in the vertical plane as seen in FIGS. 52 and 53, respectively.

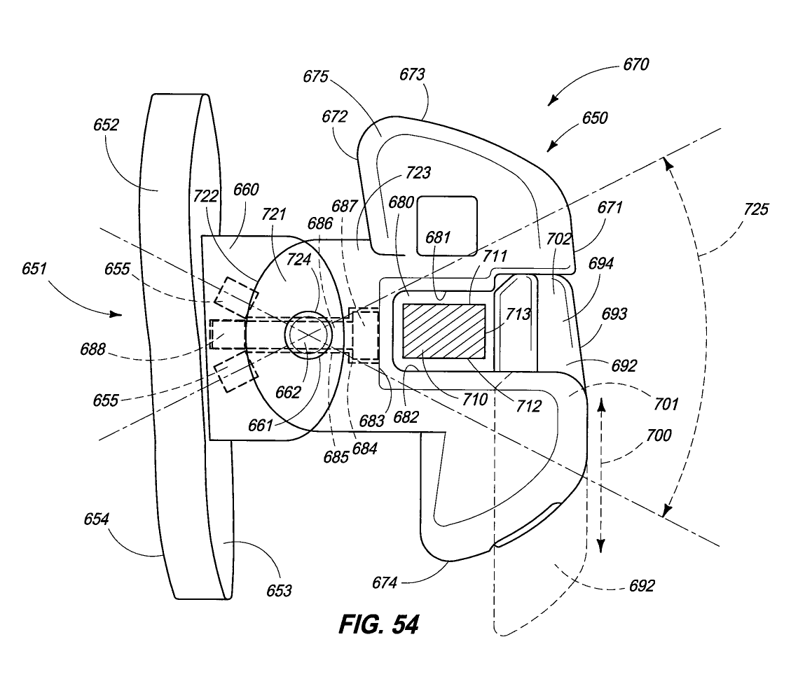

The ninth form of the invention 650, and more specifically the anterior facing surface 671, of the bracket body 670, has formed therein a vertically oriented gate channel 690. The vertically orientated gate channel has positioned substantially centrally thereof a resilient spring 691 which is operable to matingly cooperate and control the movement of a movable gate 692 which is similar to that shown with the seventh form of the invention. The movable gate 692 has an anterior facing surface 693, and which has formed therein a pair of vertically oriented guidance channels 694 along the vertically oriented peripheral edges thereof. The respective vertically oriented guidance channels slideably couple, or cooperatively mate with, the vertically oriented gate channel 690 so as to define a course of travel for the moveable gate 692. Additionally, and as will be seen in FIG. 49, a spring receiving channel 695 is formed in the posterior facing surface of the moveable gate 692, and is operable to matingly cooperate with the spring 691. The moveable gate as seen in FIG. 54 is operable to move along a path of travel 700 between a first, nonoccluding or down position 701, which allows access to the transversely disposed arch wire slot 680, and a second, occluding or up position 702, as shown in the same drawing. When located in the second, occluding or up position 702, the moveable gate 692 is operable to enclose a rectangularly shaped arch wire of traditional design within the arch wire slot 680 to achieve the benefits of the present invention.

As seen in FIGS. 52 to 54, an arch wire 710, of conventional design is received within the transversely disposed arch wire slot 680. The rectangularly shaped arch wire, is defined, in part, by a top or superior facing surface 711, and an opposite bottom, or inferior facing surface 712. Still further the arch wire has sidewalls 713 which couple the top and bottom surfaces together. As illustrated, in the drawings, the arch wire, is operable to engage the top and bottom surfaces 711 and 712 to form various torque couples 714 which exert force which is transmitted by the bracket body 670, to the bracket base 651, and which causes first, second and third order movements in the patient's tooth 11 in order to achieve the orthodontic benefits achieved by the present invention.

As seen in FIG. 47, and following, the bracket body 670 is rotatably moveable relative to the bracket base 651 by an axle receiving member 720 which extends posteriorly, rearwardly, relative to the posterior facing surface 672. In this regard, the axle receiving member has a main body 721 which has a posterior facing peripheral edge 722, and which as seen in profile in FIG. 52, and following, is substantially curved so as to matingly cooperate with the anterior facing surface 653 of the bracket base 651. Additionally, the axle receiving member is defined by a pair of spaced, substantially parallel sidewalls 723. The main body, as measured between the sidewalls 723, has a width dimension which is less than the dimensions of the gap 664 which is defined between the pair of spaced support member 660. Additionally, and as seen in FIG. 47, individual axle receiving passageways 724 are formed in the respective sidewalls 723, and are operable to be coaxially aligned relative to the axle passageways 661 which are formed in the respective pair of spaced support members 660. When substantially coaxially aligned, the respective axles 662, and more specifically the distal ends 663, thereof, are individually operable to be received within the axle receiving passageways 724 thereby rendering the main body 721 rotatable thereabout the respective axle member 662. As seen in FIG. 47, the respective locking member passageways 685 extend through the main body 721 thereby allowing the distal ends 688 of the respective locking members 686 to extend, posteriorly, rearwardly, therefrom, and be individually received within one of the plurality of locking member channels 655. A clinician by choosing either the first group 656, or the second group 657, can readily, fixedly, position the bracket body 670 in given predetermined orientations as seen in FIGS. 52 through 54 respectively in order to achieve the torquing couples 714 which are desired so as to impart a predetermined force on a patient's tooth 11 and thereby achieve first, second and third order movements as earlier described. The bracket body 670 moves along a vertically disposed path of travel 725 as seen in FIGS. 52 through 54 respectively.

### Operation

The operation of the described embodiments of the present invention are believed to be readily apparent, and are briefly summarized at this point.

In its broadest aspect, the present invention which can be utilized in either a traditional tied active and/or passive self ligation mode relates to an orthodontic bracket 10 which, in the first form of the invention 20, includes a bracket base 21, and which is releasably affixed to an anterior facing surface 12 of a patient's tooth 11. The present invention also include a bracket body 30, which as seen in the first form of the invention 20, is borne on the bracket base 21, and which further has an anterior facing surface 32. The bracket body 30 defines a transversely disposed arch wire slot 60. The present invention as seen in the first form 20, has an arch wire 75 which is received within the transverse, arch wire slot 60. The orthodontic bracket 20, acting in combination with the arch wire 75, is adjustable while affixed to the anterior facing surface 12 of the patient's tooth 11, so as to provide a multiplicity of selective torque expressions which individually, forcibly act upon the patient's tooth 11, and which facilitates first, second and third order movements. As seen with respect to the various forms of the invention as disclosed, the orthodontic bracket 10 can be employed to achieve, first, second and third orders of movement 13, 14 and 15, respectively, of the patient's tooth 11 without a clinically predetermined manipulation, bending, distortion, or rotation of the arch wire 75, other than merely placing the rectangularly shaped arch wire within the arch wire slot 60. Stated somewhat differently, the present invention substantially removes the need for a clinician to make predetermined, calculated, bends or rotations to the arch wire 75 so as to achieve the desired first, second and third order movements of a patient's tooth 11. As earlier disclosed, the determination and preparation of these predetermined bends, distortions, or rotations to the arch wire 75 have been difficult to achieve, and to calculate in normal clinical practice. The orthodontic bracket 20, as seen in the drawings, includes a bracket body 30 which is immovably affixed to the bracket base 21. In an alternative form of the invention, the orthodontic bracket 100, as illustrated, includes a bracket body 120 which is partially, rotatably movable relative to the bracket base 101.

In the second form of the invention as seen in the drawings, the orthodontic bracket 100 includes a bracket body 120 which may be only partially, rotatably movable in one axis relative to the bracket base 101. In another possible form of the invention, the orthodontic bracket 360 includes a bracket body 380 which is partially, rotatably moveable in two axes of movement which are substantially perpendicular to each other. In the sixth form of the invention 360, the bracket body is partially, rotatably moveable in two axes of movement, and the transverse rectangularly shaped arch wire slot 404 is independently, moveably, adjustable relative the bracket base 361. In the first form of the invention 20, the transverse, arch wire slot 60 has a longitudinal axis 55, and is further selectively rotatable about the longitudinal axis. As seen in the first form of the invention 20, the orthodontic bracket is an active, self-ligating orthodontic bracket. However, in the form of the invention as seen at numeral 150, the orthodontic bracket is a passive self-ligating orthodontic bracket. As seen in the drawings, the orthodontic bracket 150 has a bracket body 170 which is rotatable in a predetermined, substantially vertically oriented plane, when the bracket base 151 is affixed on the anterior surface of the patient's tooth 11. In the sixth form of the invention, the orthodontic bracket 360 has a bracket body 380 which is rotatable in a predetermined, substantially horizontally oriented plane, when the bracket base 361 is affixed on the anterior facing surface 12 of the patient's tooth 11. In the first form of the invention 20, the orthodontic bracket further includes an engagement member or retaining pin 70 which positions or retains the arch wire insert 50, in a predetermined orientation relative to the bracket base 20, so as to provide a given torque expression. The orthodontic bracket as illustrated, and which has been given the numeral 150 (FIG. 11), further includes an engagement or locking member 214 (FIG. 12) and which is positioned between the bracket body 240, and the bracket base 231, so as to prevent the movement of the bracket body 240. In the second form of the invention, the orthodontic bracket 100 has an aperture or passageway 116 which is formed in each of the support members 110 that are mounted on the bracket base 101, and a multiplicity of semi-circular apertures 143 are formed in the bracket body 120. When these apertures or features are coaxially aligned, at least in part, with the passageway 116, they are operable to receive an engagement or locking member 144 therethrough, and which is effective in maintaining the bracket body 120 in a given orientation relative to the bracket base so as to provide a given torque expression. In the first form of the invention 20, the orthodontic bracket, as shown, defines a transversely disposed and rectangularly shaped arch wire slot 60 which is further defined by the arch wire insert 50. The arch wire insert 50 is rotatably mounted, and located, at least in part, within the bracket body 30. In the first form of the invention 20, the engagement member or retainer pin 70 is provided, and which is used to engage both the rotatable arch wire insert 50, and the bracket body 30, and which is operable to maintain the rotatable arch wire insert 50 within the bracket body 30. In the sixth form of the invention, the orthodontic bracket 360 further includes a rotational adjustment member 420 which is sandwiched between the bracket body 380, and bracket base 361, and which fixes the relative rotational orientation of the bracket body 380 relative to the bracket base 361.

A second aspect of the present invention relates to an orthodontic bracket 20, and which includes a bracket base 21 which is releasably affixed to an anterior facing surface 12 of a patient's tooth 11; and a bracket body 30 mounted on the bracket base 21, and which has an anterior facing surface 32, and which further defines a transversely disposed cavity 41. The orthodontic bracket 20 further includes an arch wire insert 50 having a main body 51, and which is defined by a longitudinal axis 55, and which is further received within the transversely disposed cavity 41. The main body 51 further defines a transversely disposed arch wire slot 60. The arch wire insert 50 is selectively rotatable about the longitudinal axis 55 thereof. The orthodontic bracket 20 further includes an arch wire 75 which is received within the transversely oriented arch wire slot 60, and which, acting in combination with arch wire insert 50, provides a multiplicity of selective torque expressions to effect first, second and third order movements 13, 14 and 15, respectively, and which individually forcibly act upon the patient's tooth 11. As noted above, the arch wire insert 50 is selectively rotatable along a given path of travel 74, and about the longitudinal axis 55, and in a range of movement of less than about 60 degrees relative to the bracket body 30. The arch wire 75 can pass through both the aperture 43 which is defined by the bracket body, and the opening 61, which is defined by the main body 51 of the arch wire insert 50, and be received in the arch wire slot 75 while the arch wire insert 50 is located along the path of travel 74. The orthodontic bracket 20 of the present invention, as noted above, includes a transversely disposed cavity 41 which is substantially cylindrically shaped, and the main body 51 of the arch wire insert 50 is cylindrically shaped, and is sized so as to be coaxially, telescopingly, received within the transversely disposed cavity. The main body 51 of the arch wire insert 50 has a first end 53, and an opposite second end 54. The arch wire slot 60 extends between the opposite first and second ends of the main body 51.

Still another aspect of the present invention relates to an orthodontic bracket 150 which includes a bracket base 151 which is releasably affixed to an anterior facing surface 12 of a patient's tooth 11, and a bracket body 170 which moveably cooperates with the bracket base 150. The anterior facing surface of the bracket body 151 defines a transversely disposed arch wire slot 180 which can be accessed through an aperture 177 and which is formed in the anterior facing surface 173 of the bracket body 170. The orthodontic bracket 150 includes a gate 190 which is moveably borne by the anterior facing surface 172 of the bracket body 170, and which further can move along a path of travel 200 from a first, open position 201, where access to the arch wire slot 180 from the anterior facing surface 172 of the bracket body 170 is substantially unobstructed, to a second, closed position 202, where the gate 190 occludes the aperture 177 which is formed in the anterior facing surface 172 of the bracket body 170, and which further impedes access to the arch wire slot 180 by way of the anterior facing surface 172 of the bracket body 170. Still further, the orthodontic bracket includes a rectangularly shaped arch wire 184 which is received within the transversely disposed arch wire slot 180, and which is further retained therein when the gate 190 is located in the second, occluding, closed, or blocking position 202. In the present invention, the moveable bracket body 170, acting in combination with the arch wire 184, provides a multiplicity of torque expressions which individually forcibly act upon the patient's tooth 11.

Still yet another aspect of the present invention relates to an orthodontic bracket 650, which includes a bracket based 651, which is releasably affixed to an anterior facing surface 12 of a patient's tooth 11; a bracket body 670 which is borne by the bracket base 651, and which further has a selectively adjustable, and transversely disposed arch wire slot 680; and an arch wire 710 received within the selectively adjustable transversely disposed arch wire slot 680, and wherein the selectively adjustable transversely disposed arch wire slot 680, acting in combination with the arch wire 710, provides a multiplicity of selective torque expressions which individually, forcibly act upon the patient's tooth 11.

Therefore, it will be seen that the present invention provides a convenient means whereby a clinician can conveniently treat a patient having various dental and other tooth anomalies by employing an orthodontic bracket, and an associated arch wire in a fashion which allows minimal force to be applied to the patient's tooth, but which further allows a clinician to impart sufficient force to effect first, second and third order movements in order to correct deficiencies in the alignment of patient's teeth in a manner not possible heretofore.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the Doctrine of Equivalents.

We claim:

1. An orthodontic bracket, comprising:
a bracket base which is releasably affixed to an anterior facing surface of a patient's tooth;
a bracket body borne on the bracket base, and which further has an anterior facing surface which defines a transversely disposed, arch wire slot; and
an arch wire received within the transversely disposed, arch wire slot, and wherein the orthodontic bracket, acting in combination with the arch wire, is adjustable while affixed to the anterior surface of the patient's tooth, to provide a multiplicity of selective torque expressions which individually, forcibly act upon the patient's tooth.

2. An orthodontic bracket as claimed in claim 1, and wherein the orthodontic bracket can be employed to achieve, a first, second and third orders of movement of the patient's tooth without a clinically predetermined manipulation of the arch wire which is received in the transverse, arch wire slot.

3. An orthodontic bracket as claimed in claim 2, and wherein the bracket body is immovably affixed to the bracket base.

4. An orthodontic bracket as claimed in claim 2, and wherein the bracket body is partially, rotatably moveable relative to the bracket base.

5. An orthodontic bracket as claimed in claim 2, and wherein the bracket body is partially, rotatably moveable in one axis of movement relative to the base.

6. An orthodontic bracket as claimed in claim 2, and wherein the bracket body is partially, rotatably moveable in two axes of movement which are substantially perpendicular to each other.

7. An orthodontic bracket as claimed in claim 2, and wherein the bracket body is partially, rotatably moveable in two axes of movement, and the transversely disposed arch wire slot is independently, moveably, adjustable relative the bracket base.

8. An orthodontic bracket as claimed in claim 2, and wherein the transversely disposed, arch wire slot has a longitudinal axis, and is further selectively rotatable about the longitudinal axis.

9. An orthodontic bracket as claimed in claim 2, and wherein the orthodontic bracket is an active self-ligating orthodontic bracket.

10. An orthodontic bracket as claimed in claim 2, and wherein the orthodontic bracket is a passive self-ligating orthodontic bracket.

11. An orthodontic bracket as claimed in claim 4, and wherein the bracket body is rotatable in a predetermined, substantially vertically oriented plane, when the bracket base is affixed on the anterior surface of the patient's tooth.

12. An orthodontic bracket as claimed in claim 4, and wherein the bracket body is rotatable in a predetermined, substantially horizontally oriented plane, when the bracket base is affixed on the anterior surface of the patient's tooth.

13. An orthodontic bracket as claimed in claim 8, and wherein the longitudinal axis of the transversely disposed, arch wire slot is substantially horizontally oriented when the bracket body is affixed on the anterior surface of the patient's tooth.

14. An orthodontic bracket as claimed in claim 13, and further comprising an engagement member which positions the bracket body, in a predetermined orientation relative to the bracket base, so as to provide a given torque expression.

15. An orthodontic bracket as claimed in claim 14, and wherein the engagement member is positioned between the bracket body, and the bracket base, so as to prevent the movement of the bracket body.

16. An orthodontic bracket as claimed in claim 14, and wherein an aperture is formed in each of the bracket base, and bracket body, respectively, and which, when coaxially aligned, are operable to receive the engagement member therethrough, and which is effective in maintaining the bracket body in a given orientation to the bracket base so as to provide a given torque expression.

17. An orthodontic bracket as claimed in claim 16, and wherein a multiplicity of apertures are formed in the bracket body, at given locations, and only one aperture is formed in the bracket base, and wherein the multiplicity of apertures when individually, coaxially aligned with the one aperture formed in the bracket base, facilitates the orientation of the bracket body so as to be readily, positionally adjustable, and further causes the orthodontic bracket to exhibit the multiplicity of individual torque expressions.

18. An orthodontic bracket as claimed in claim 16, and wherein a multiplicity of apertures are formed in both the bracket base, and the bracket body and are further operable to be coaxially aligned one with the other, and which facilitates the orientation of the bracket body relative to the bracket base.

19. An orthodontic bracket as claimed in claim 18, and wherein a locking member is provide and which is received in one of the coaxially aligned apertures and which is effective in rotatably fixing the orientation of the bracket body relative to the bracket base.

20. An orthodontic bracket as claimed in claim 3, and wherein the transversely disposed, arch wire slot is defined by an arch wire insert which is rotatably mounted, and located, at least in part, within the bracket body.

21. An orthodontic bracket as claimed in claim 20, and further comprising an engagement member which is used to engage both the rotatable arch wire insert, and the bracket body, and which is operable to maintain the rotatable arch wire insert within the bracket body.

22. An orthodontic bracket as claimed in claim 21, and further comprising a pair of locking members which are used to engage both the rotatable arch wire insert, and the bracket body, and which is operable to maintain the rotatable arch wire insert in a predetermined rotational orientation relative to the bracket base.

23. An orthodontic bracket as claimed in claim 4, and further comprising a rotatable adjustment member which is sandwiched between the bracket body, and bracket base, and which fixes the relative rotational orientation of the bracket body relative to the bracket base.

24. An orthodontic bracket, comprising:
a bracket base which is releasably affixed to an anterior facing surface of a patient's tooth;
a bracket body mounted on the bracket base, and which has an anterior facing surface which defines a transversely disposed cavity;
an arch wire insert having a main body which is defined by a longitudinal axis, and which is further received within the transversely disposed cavity, and wherein the main body further defines a transversely oriented arch wire slot, and wherein the arch wire insert is selectively rotatable about the longitudinal axis thereof; and
an arch wire received within the transversely oriented arch wire slot, and which, acting in combination with arch wire insert, provides a multiplicity of selective torque expressions which individually forcibly act upon the patient's tooth.

25. An orthodontic bracket as claimed in claim 24, and wherein the selective rotatable positioning of the arch wire insert, and which acts upon the arch wire which is received in the arch wire slot, achieves predetermined first, second and third orders of movement of the patient's tooth.

26. An orthodontic bracket as claimed in claim 25, and wherein the transversely disposed cavity is defined, at least in part, by an aperture which is formed in the anterior facing surface of the bracket body, and which has a predetermined cross sectional dimension.

27. An orthodontic bracket as claimed in claim 26, and wherein the main body of the arch wire insert has an exterior facing surface, and wherein the arch wire slot is defined, at least in part, by an opening which is formed in the exterior facing surface, and wherein the arch wire slot extends from the exterior facing surface of the main body, and in the direction of the longitudinal axis thereof, and wherein the opening has a cross sectional dimension which is less than the cross sectional dimension of the aperture defined by the anterior facing surface of the bracket body.

28. An orthodontic bracket as claimed in claim 27, and wherein a portion of the exterior facing surface of the main body of the arch wire insert extends outwardly through the aperture, and which is defined by the bracket body, and is further located anteriorly, outwardly, relative to the anterior facing surface thereof.

29. An orthodontic bracket as claimed in claim 28, and wherein the arch wire insert is selectively rotatable along a given path of travel about the longitudinal axis, and in a range of movement of less than about 60 degrees relative to the bracket body, and wherein the arch wire can pass through both the aperture defined by the bracket body, and the opening defined by the main body of the arch wire insert, and be received in the arch wire slot while the arch wire insert is located along the path of travel.

30. An orthodontic bracket as claimed in claim 29, and wherein the transversely disposed cavity of the bracket body is substantially cylindrically shaped, and the main body of the arch wire insert is cylindrically shaped, and is sized so as to be coaxially, telescopingly, received within the transversely disposed cavity, and wherein the main body of the arch wire insert has a first end, and an opposite second end, and wherein the arch wire slot extends between the opposite first and second ends of the main body.

31. An orthodontic bracket as claimed in claim 30, and wherein the arch wire slot is defined by a pair of substantially opposed, superior and inferior facing surfaces, and which are further oriented in substantially predetermined, spaced, parallel relationship, one relative to the other, and a rear wall which extends between the opposed superior, and inferior facing surfaces, and which is located posteriorly, inwardly, relative to the outside facing surface of the main body of the arch wire insert.

32. An orthodontic bracket as claimed in claimed 31, and wherein an elongated engagement channel is formed in the bracket body, and which communicates with the transversely disposed cavity, and which further extends substantially along a vertical plane relative to the bracket body, and wherein the main body of the arch wire insert defines a passageway which extends generally radially between the rear wall of the arch wire slot to the exterior facing surface thereof, and wherein the passageway is aligned, and communicates with, the elongated engagement channel formed in the bracket body.

33. An orthodontic bracket as claimed in claim 32, and further comprising a first engagement member having opposite proximal and distal ends, and which is received within the passageway defined by the main body of the arch wire insert, and wherein the distal end of the engagement member is received within the elongated engagement channel so as to substantially fix the orientation of the arch wire insert within the transversely disposed cavity as defined by the bracket body.

34. An orthodontic bracket as claimed in claim 32, and further comprising a multiplicity of locking channels formed in the bracket base and communicating with the transversely disposed cavity of the bracket body, and wherein a pair of locking member passageways are formed in the rear wall of the arch wire slot, and extend to the exterior facing surface of the main body of the arch wire insert, and wherein a pair of locking members are received in the respective locking member passageways and which further engage the individual locking member channels formed in the bracket base, and which are effective in selectively, rotatably fixing the main body of the arch wire insert in a predetermined fixed orientation relative to the bracket base.

35. An orthodontic bracket as claimed in claim 33, and wherein the bracket body further defines opposed tie wings, and wherein a ligature extends between the opposed tie wings which are defined by the bracket body, and which further frictionally engages the portion of the main body of the arch wire insert which extends anteriorly outwardly relative the anterior facing surface of the bracket body.

36. An orthodontic bracket, as claimed in claim 35, and further comprising a second passageway which is formed in the bracket body, and which extends from an outside facing surface of the bracket body, and in the direction of, and coupling to, the transversely disposed cavity which is defined by the bracket body; and a locking member is received in the second passageway, and which further has a distal end which frictionally engages the main body of the arch wire insert, and which fixes the arch wire insert at a predetermined rotational orientation along the path of travel.

37. An orthodontic bracket as claimed in claim 36, and further comprising opposed end caps, and wherein the bracket body has opposite ends, and wherein the opposed end caps are affixed on the opposite ends of the bracket body and which further rotatably retain the arch wire insert within the transversely disposed cavity which is defined by the bracket body.

38. An orthodontic bracket as claimed in claim 37, and wherein a passageway is formed in the bracket body, and which extends though the bracket body, and communicates with the transversely disposed cavity, and wherein a locking member is provided, and which is sized so as to be received in the passageway, and wherein the locking member has a distal end which frictionally engages the arch wire insert so as to fix the arch wire insert at a predetermined rotational orientation relative to the path of travel.

39. An orthodontic bracket as claimed in claim 38, and wherein a passageway is formed in at least one of the opposed end caps and which communicates with the transversely disposed cavity, and wherein a locking member is sized so as to be received in the passageway, and which further has a distal end which frictionally engages the arch wire insert so as to fix the arch wire insert at a predetermined rotational orientation relative to the path of travel.

40. An orthodontic bracket, comprising:
a bracket base which is releasably affixed to an anterior facing surface of a patient's tooth;
a bracket body moveably cooperating with the bracket base, and wherein the bracket body has an anterior facing surface, and further defines a transversely disposed arch wire slot which communicates with the anterior facing surface of the bracket body; and
an arch wire received within the transversely disposed arch wire slot, and wherein the moveable bracket body, acting in combination with the arch wire provides a multiplicity of torque expressions which individually, forcibly act upon the patient's tooth.

41. An orthodontic bracket as claimed in claim 40, and wherein the bracket body, acting upon the arch wire, can selectively effect first, second, and third orders of movement of the patient's tooth by utilizing the same arch wire.

42. An orthodontic bracket as claimed in claim 41, and wherein the bracket body is rotatable in a predetermined vertical plane, when the bracket base is affixed on the anterior surface of the patient's tooth.

43. An orthodontic bracket as claimed in claim 42, and wherein the bracket body is rotatable in a predetermined horizontal plane, when the bracket base is affixed on the anterior facing surface of the patient's tooth.

44. An orthodontic bracket as claimed in claim 43, and wherein the bracket body is selectively rotatable along a predetermined path of travel, and in a range of movement which is less that about 60 degrees relative to the bracket base.

45. An orthodontic bracket as claimed in claim 44, and wherein the bracket base has a pair of spaced, support members, which each have a coaxially aligned passageway formed therein, and wherein an axle is received in the coaxially aligned passageways, and the bracket body is supported on, and rotates about the axle.

46. An orthodontic bracket as claimed in claim 45, and further comprising an engagement member which matingly cooperates with at least one of the support members, and the bracket body, and which positions the bracket body in a predetermined orientation relative to the bracket base to effect one of the given torque expressions when cooperating with the arch wire.

47. An orthodontic bracket as claimed in claim 46, and wherein the respective spaced, support members which are borne on the bracket base have a distal, anterior oriented end, which has a curved shape.

48. An orthodontic bracket as claimed in claim 47, and further comprising an engagement member which is positioned between the bracket body, and the bracket base, and which prohibits the movement of the bracket body.

49. An orthodontic bracket as claimed in claim 48, and wherein the bracket body further defines opposed tie wings, and wherein a ligature extends between the opposed tie wings which are defined by the bracket body, and further, secures the arch wire within the arch wire slot.

50. An orthodontic bracket as claimed in claim 44, and wherein the bracket body has a pair of spaced, support members which extend posteriorly, outwardly and which each have a coaxially aligned passageway formed therein, and wherein an axle is matingly received in the coaxially aligned passageways, and wherein an axle engagement member is mounted on the bracket base, and extends anteriorly, outwardly, relative thereto, and wherein the axle engages the axle engagement member, and rotates relative thereto, and wherein a space is defined between the bracket base and the bracket body.

51. An orthodontic bracket as claimed in claim 50, and further comprising a rotational adjustment member which is sandwiched between the bracket body, and the bracket base, and which fixes the relative rotational orientation of the bracket body relative to the bracket base.

52. An orthodontic bracket, comprising:
a bracket base which is releasably affixed to an anterior facing surface of a patient's tooth;
a bracket body moveably cooperating with the bracket base, and wherein the anterior facing surface of the bracket body defines a transversely disposed arch wire slot which can be accessed through an aperture formed in the anterior facing surface of the bracket body;
a gate moveably borne on the anterior facing surface of the bracket body, and which can reciprocally move along a path of travel from a first position, where access to the arch wire slot from the anterior facing surface of the bracket body is substantially unobstructed, to a second position, where the gate occludes the aperture formed in the anterior facing surface of the bracket body, and which further impedes access to the arch wire slot by way of the anterior facing surface of the bracket body; and
an arch wire received within the transversely disposed arch wire slot, and which is further retained, therein, when the gate is located in the second position, and wherein the moveable bracket body, acting in combination with the arch wire, provides a multiplicity of torque expressions which individually, forcibly act upon the patient's tooth.

53. An orthodontic bracket as claimed in claim 52, and wherein the multiplicity of torque expressions include first, second and third order movements, and wherein these respective orders of movement can be achieved with the same arch wire.

54. An orthodontic bracket as claimed in claim 53, and wherein the bracket body is selectively rotatable along a path of travel, and within a range of movement which is less than about 60 degrees relative to the bracket base.

55. An orthodontic bracket as claimed in claim 54, and wherein the bracket base mounts a pair of spaced, support members, which each have a passageway that is formed therein, and which are respectively, coaxially aligned with the other, and wherein an axle is received in the coaxially aligned passageways, and the bracket body is supported on, and selectively rotates about the axle, and wherein a gap having a predetermined dimension, is defined between the spaced, support members, and wherein a second passageway is formed in at least one of the pair of spaced, support members.

56. An orthodontic bracket as claimed in claim 55, and wherein the bracket body has a posterior facing surface, and wherein an axle receiving member, which has a main body, is mounted on the posterior facing surface, and which further extends posteriorly, outwardly relative thereto, and wherein the main body of the axle receiving member defines an axle passageway, through which, the axle passes, and further has a predetermined thickness dimension, and is further defined by a peripheral edge.

57. An orthodontic bracket as claimed in claim 56, and wherein the thickness dimension of the main body of the axle receiving member is less than the gap dimension which is defined between the pair of spaced, support members, and wherein the main body of the axle receiving member is received in the gap, and the peripheral edge of the main body of the axle receiving member is located in spaced relation relative to the bracket base.

58. An orthodontic bracket as claimed in claim 57, and wherein the peripheral edge of the main body of the axle receiving member is at least partially, and generally, curvi-linear in shape, and wherein a plurality of semi-circular cavities are formed in spaced, predetermined locations along the peripheral edge of the axle receiving member, and which further can be individually, substantially, coaxially aligned with the second passageway, and which is formed in one of the pair of spaced support members, when the bracket body is rotated about the axle, and wherein an engagement member is provided, and which is sized so as to be received in the coaxially aligned, second passageway, and one of the plurality of semi-circular cavities formed along the peripheral edge of the axle receiving member so as to substantially fix the rotational orientation of the bracket body relative to the bracket base, and wherein the plurality of semi-circular cavities permit the bracket body to be moveably fixed in a plurality of predetermined orientations so as to provide the multiplicity of torque expressions.

59. An orthodontic bracket as claimed in claim 57, and wherein the peripheral edge of the axle receiving member defines a multiplicity of discrete, flat surfaces, and wherein, when the bracket body is rotated the respective discrete, flat surfaces, can be individually oriented in substantially parallel, spaced relation relative to the bracket base, and wherein an engagement member is provided and which is sized so as to be received between the respective flat surfaces of the axle receiving member and the base member, and which is operable to selectively rotatably fix the orientation of the bracket body relative to the bracket base.

60. An orthodontic bracket as claimed in claim 58, and wherein the peripheral edge of the main body of the axle receiving member is at least partially, and generally, curvi-linear in shape, and wherein a plurality of semi-circular cavities are formed in spaced, predetermined locations along the peripheral edge of the axle receiving member, and wherein a predetermined plurality of regions of the peripheral edge of the axle receiving member, and which are each located between the adjacent semi-circular cavities, are generally linear in shape, and wherein, a space, having given dimensions, is defined between the respective regions of the peripheral edge having the linear shape, and the bracket base, and wherein an engagement member is provided, and which is sized so as to be received in the space which is defined between the respective regions having the linear shape, and the bracket base, and which fixes the rotational orientation of the bracket body relative to the bracket base in a multiplicity of predetermined rotational orientations so as to provide the resulting multiplicity of torque expressions which are applied to the patient's tooth.

61. An orthodontic bracket as claimed in claim 60, and wherein the bracket body is selectively rotatable along a substantially vertically oriented plane.

62. An orthodontic bracket as claimed in claim 54, and wherein the bracket body is selectively rotatable along a substantially horizontally oriented plane.

63. An orthodontic bracket as claimed in claim 62, and wherein the bracket body has a pair of spaced, support members which extend posteriorly, outwardly relative thereto, and which each have a coaxially aligned passageway formed therein, and wherein an axle is matingly received in the coaxially aligned passageways, and wherein an axle engagement member is mounted on the bracket base, and extends anteriorly, outwardly, relative thereto, and wherein the axle engages the axle engagement member, and rotates relative thereto, and wherein a space is defined between the bracket base and the bracket body.

64. An orthodontic bracket as claimed in claim 63, and further comprising a rotation adjustment member which is sandwiched between the bracket body, and the bracket base, and which fixes the relative rotational orientation of the bracket body, relative to the bracket base.

65. An orthodontic bracket as claimed in claim 64, and wherein the rotation adjustment member has a main body with an anterior and posterior facing surface, and which is further defined by a pair of spaced, depending legs, and a bridge having opposite ends, and which is mounted to each of the depending legs, and wherein a gap is defined between the depending legs and which is sized so that the respective depending legs can be positioned on opposite sides of the axle engagement member.

66. An orthodontic bracket as claimed in claim 64, and wherein a handle is mounted on the bridge and which extends superiorly upwardly therefrom, and wherein the handle is employed to appropriately place the rotation adjustment member between the bracket base, and the rotatable bracket body.

67. An orthodontic bracket as claimed in claim 66, and wherein each of the depending legs, and the bridge, have substantially the same width dimension.

68. An orthodontic bracket as claimed in claim 66, and wherein each of the depending legs, and the bridge, have a different width dimension.

69. An orthodontic bracket as claimed in claim 66, and wherein each of the depending legs and the bridge have individually non-uniform width dimensions.

70. An orthodontic bracket, comprising:
a bracket base which is releasably affixed to an anterior facing surface of a patient's tooth;
a bracket body borne on the bracket base, and which further has a selectively adjustable transversely disposed arch wire slot; and
an arch wire received within the selectively adjustable transversely disposed arch wire slot, and wherein the selectively adjustable transversely disposed arch wire slot, acting in combination with the arch wire, provides a multiplicity of selective torque expressions which individually, forcibly act upon the patient's tooth.

71. An orthodontic bracket as claimed in claim 70, and wherein the bracket body is selectively rotatably moveable relative to the bracket base, and in a predetermined plane.

72. An orthodontic bracket as claimed in claim 70, and wherein the bracket body is selectively rotatably moveable relative to the bracket base.

73. An orthodontic bracket as claimed in claim 70, and wherein the bracket body is immovably affixed to the bracket base, and the orthodontic bracket further comprises an arch wire insert having a main body, and which is rotatably moveable relative to the bracket body, and wherein the transversely disposed arch wire slot is formed in the arch wire insert, and further has a longitudinal axis, and wherein the arch wire insert is further selectively rotatable about the longitudinal axis.

74. An orthodontic bracket as claimed in claim 73, and wherein the bracket body defines a transversely disposed cavity which matingly, and rotatably supports the arch wire insert, and wherein the cavity is defined by a sidewall, which has formed therein an elongated engagement channel which extends substantially along a vertical plane relative to the bracket body, and a multiplicity of locking member channels are formed in a predetermined pattern in the bracket body sidewall.

75. An orthodontic bracket as claimed in claim 74, and wherein the respective locking member channels are located on opposite sides of the elongated engagement channel, and are disposed in predetermined spaced relation one relative to the others.

76. An orthodontic bracket as claimed in claim 75, and wherein the transversely disposed arch wire slot is defined by a pair of spaced, superior and inferior facing surfaces, and a sidewall which couples the superior and inferior facing surfaces together, and wherein a passageway is formed in the arch wire insert, and which extends generally radially, outwardly from the rear wall of arch wire insert, and which communicates with the elongated engagement channel, and wherein an engagement member, having a distal end, is received in the passageway, and wherein the distal end thereof extends outwardly relative to the arch wire insert, and is further matingly received within the elongated engagement channel so as to retain the arch wire insert in rotatable moveable relation relative to the bracket body.

77. An orthodontic bracket as claimed in claim 76, and further comprising a locking member passageway which is formed in the rear wall of the transversely disposed arch wire slot, and which further extends radially, outwardly therefrom, and which additionally communicates with the multiplicity of locking member channels, and wherein a locking member is provided, and which has a distal end, and which is received within the locking member passageway, and wherein the distal end of the locking member, when received within one of the multiplicity of locking member channels, is effective in fixedly orienting the arch wire insert in a given rotational position relative to the bracket body.

78. An orthodontic bracket as claimed in claim 77, and wherein the locking member passageway includes a second locking member passageway, and wherein the respective locking member passageways are located on the opposite sides of the passageway which is aligned with the elongated engagement channel.

79. An orthodontic bracket as claimed in claim 71, and further comprising:
a gate which is moveably borne by the bracket body, and which can reciprocally move along a path of travel from a first position, where access to the arch wire slot is substantially unobstructed, to a second position, where the gate substantially occludes and obstructs access to the arch wire slot.

80. An orthodontic bracket as claimed in claim 79, and wherein the arch wire slot is defined by a pair of spaced, superior and inferior facing surfaces, and a sidewall which couples the superior and inferior facing surfaces together, and wherein a pair of locking member passageways are formed in the sidewall of the arch wire slot and which individually extend posteriorly, outwardly relative thereto, and wherein individual locking members are provided and are received in each of the respective locking member passageways, and wherein each locking member has a distal end.

81. An orthodontic bracket as claimed in claim 80, and wherein the bracket base rotatably supports the bracket body for rotation about an axis, and wherein the bracket base has a posterior facing surface which has formed therein a multiplicity of locking member channels which are formed in a given pattern, and which when properly aligned, communicate with one of the pair of locking member passageways, and wherein the distal ends of the respective locking members are operable to be received in individual locking member passageways, and are individually effective in selectively, rotatably positioning the bracket body relative to the bracket base.
